(19) United States
(12) Patent Application Publication
(10) Pub. No.: US 2026/0239120 A1
(43) Pub. Date: Aug. 13, 2026

(54) TRANSMIT POWER FOR INTER BAND CA

(71) Applicant: LG ELECTRONICS INC., Seoul (KR)

(72) Inventors: Yoonoh YANG, Seoul (KR); Sangwook LEE, Seoul (KR); Joongkwan HUH, Seoul (KR); Jinyup HWANG, Seoul (KR); Jinwoong PARK, Seoul (KR); Yunsik NA, Seoul (KR)

(73) Assignee: LG ELECTRONICS INC., Seoul (KR)

(21) Appl. No.: 19/470,717

(22) PCT Filed: Mar. 28, 2024
(86) PCT No.: PCT/KR2024/003914

§ 371 Date: Sep. 29, 2025

Related U.S. Application Data
(60) Provisional application No. 63/455,579, filed on Mar. 30, 2023.
(60) Provisional application No. 63/466,322, filed on May 14, 2023.
(60) Provisional application No. 63/534,113, filed on Aug. 22, 2023.

(51) Int. Cl. H04W 36/00; H04W 52/14

(52) U.S. Cl. CPC H04W 36/00692; H04W 52/146

(57) ABSTRACT

The present disclosure provides a UE. The UE includes at least one transceiver; at least one processor; and at least one memory that stores instructions and is operatively electrically connectable with the at least one processor. Operations performed based on the command being executed by the at least one processor may include: transmitting a random access preamble to a base station; receiving a response message from the base station; and transmitting capability information to the base station.

### CROSS-REFERENCE TO RELATED APPLICATION(S)

This application is the National Stage filing under 35 U.S.C. 371 of International Application No. PCT/KR2024/003914, filed on Mar. 28, 2024, which claims the benefit of U.S. Provisional Application No. 63/455,579, filed on Mar. 30, 2023, 63/466,322, filed on May 14, 2023, and 63/534,113, filed on Aug. 22, 2023, the contents of which are all incorporated by reference herein in their entirety.

### TECHNICAL FIELD

The present specification relates to a radio communication.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 110 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

In prior arts, requirements related to power class 1.5 UE, which is configured with inter-band CA were not defined. Therefore, the UE cannot perform communication based on the inter-band CA.

### SUMMARY

In one aspect, a UE is provided. The UE includes at least one transceiver; at least one processor; and at least one memory that stores instructions and is operatively electrically connectable with the at least one processor. Operations performed based on the command being executed by the at least one processor may include: transmitting a random access preamble to a base station; receiving a response message from the base station; and transmitting capability information to the base station.

In another aspect, a method performed by the UE is provided.

In one aspect, a base station is provided. The base station includes at least one transceiver; at least one processor; and at least one memory that stores instructions and is operatively electrically connectable with the at least one processor. Operations performed based on the command being executed by the at least one processor may include: receiving a random access preamble from a User Equipment (UE); transmitting a response message to the UE; and receiving capability information from the UE.

In another aspect, a method by which the base station performs is provided.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 is a diagram showing an example of a communication structure that can be provided in a 6G system.

FIG. 5 shows an example of an electromagnetic spectrum.

FIGS. 6a through 6e shows an example of RACH procedures applicable to an embodiment of the present disclosure.

FIGS. 7a and 7b illustrate an example of Tx RF architecture according to an embodiment of the present disclosure.

FIGS. 8a and 8b illustrate an example of a flow chart related to supported power class an operation according to an embodiment of the present disclosure.

FIG. 9 illustrates an example of an operation according to an embodiment of the present disclosure.

FIG. 10 illustrates an example of an operation according to an embodiment of the present disclosure.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regard to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

Although a user equipment (UE) is illustrated by way of example in the accompanying drawings, the illustrated UE may be referred to as a terminal, mobile equipment (ME), and the like. In addition, the UE may be a portable device such as a notebook computer, a mobile phone, a PDA, a smartphone, and a multimedia device or may be a non-portable device such as a PC or a vehicle-mounted device.

Hereinafter, a UE is used as an example of a wireless communication device (or a wireless device or wireless equipment) capable of wireless communication. An operation performed by a UE may be performed by a wireless communication device. A wireless communication device may also be referred to as a wireless device, wireless equipment, or the like. Hereinafter, AMF may mean an AMF node, SMF may mean an SMF node, and UPF may mean a UPF node.

A base station used below generally refers to a fixed station communicating with a wireless device and may also be referred as an evolved-NodeB (eNodeB), an evolved-NodeB (eNB), a base transceiver system (BTS), an access point, and a next generation NodeB (gNB).

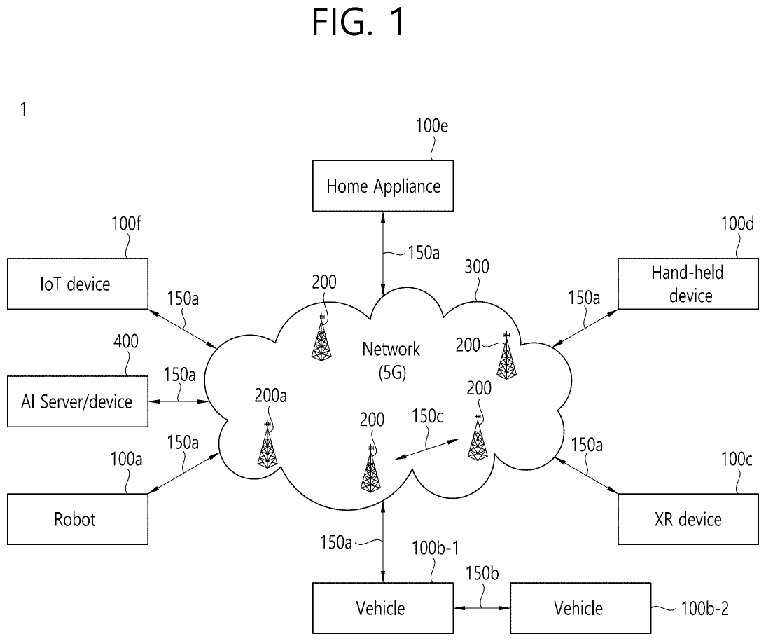

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. Alevel of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW). FR2 may include FR 2-1 and FR 2-2, as shown in the examples in Table 1 and Table 2.

TABLE 1

| Frequency Range | | Corresponding | Subcarrier |
|---|---|---|---|
| designation | | frequency range | Spacing |
| FR1 | | 450 MHz-6000 MHz | 15, 30, 60 kHz |
| FR2 | FR2-1 | 24250 MHz-52600 MHz | 60, 120, 240 kHz |
| | FR2-2 | 57000 MHz-71000 MHz | 120, 480, 960 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | | Corresponding | Subcarrier |
|---|---|---|---|
| designation | | frequency range | Spacing |
| FR1 | | 410 MHz-7125 MHz | 15, 30, 60 kHz |
| FR2 | FR2-1 | 24250 MHz-52600 MHz | 60, 120, 240 kHz |
| | FR2-2 | 57000 MHz-71000 MHz | 120, 480, 960 kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally, and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally, and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

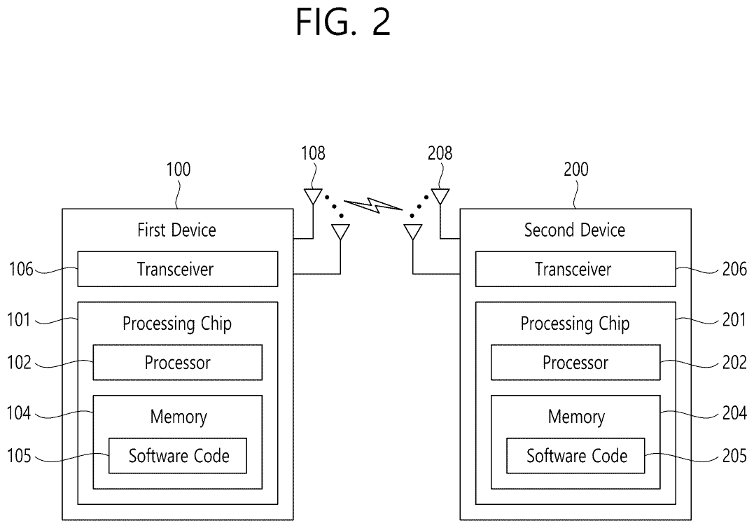

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with radio frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

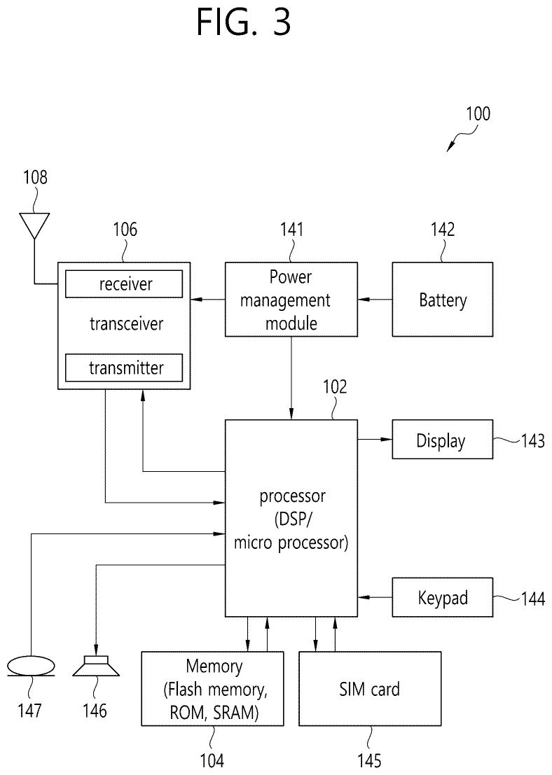

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory unit 130 may be configured by a RAM, a DRAM, a ROM, a flash memory, a volatile memory, a non-volatile memory, and/or a combination thereof.

### <Operating Bands of NR>

The operating bands in NR are as follows.

The operating bands in Table 3 below are the refarmed operating bands from the operating bands of LTE/LTE-A. This is referred to as the FR1 band.

TABLE 3

| NR | Uplink (UL) | Downlink(DL) | |
|---|---|---|---|
| operating | operating band | operating band | Duplex |
| bands | F_{UL}_low-F_{UL}_high | F_{DL}_low-F_{DL}_high | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n12 | 699 MHz-716 MHz | 729 MHz-746 MHz | FDD |
| n20 | 832 MHz-862 MHz | 791 MHz-821 MHz | FDD |
| n25 | 1850 MHz-1915 MHz | 1930 MHz-1995 MHz | FDD |
| n28 | 703 MHz-748 MHz | 758 MHz-803 MHz | FDD |
| n34 | 2010 MHz-2025 MHz | 2010 MHz-2025 MHz | TDD |
| n38 | 2570 MHz-2620 MHz | 2570 MHz-2620 MHz | TDD |
| n39 | 1880 MHz-1920 MHz | 1880 MHz-1920 MHz | TDD |
| n40 | 2300 MHz-2400 MHz | 2300 MHz-2400 MHz | TDD |
| n41 | 2496 MHz-2690 MHz | 2496 MHz-2690 MHz | TDD |
| n50 | 1432 MHz-1517 MHz | 1432 MHz-1517 MHz | TDD1 |
| n51 | 1427 MHz-1432 MHz | 1427 MHz-1432 MHz | TDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |
| n86 | 1710 MHz-1780 MHz | N/A | SUL |

The table below shows the NR operating band defined at high frequencies. This is called the FR2 band.

TABLE 4

| NR | Uplink (UL) | Downlink(DL) | Duple |
|---|---|---|---|
| Operating | operating band | operating band | × |
| band | F_{UL}_low-F_{UL}_high | F_{DL}_low-F_{DL}_high | Mode |
| n257 | 26500 MHz-29500 MHz | 26500 MHz-29500 MHz | TDD |
| n258 | 24250 MHz-27500 MHz | 24250 MHz-27500 MHz | TDD |
| n259 | 37000 MHz-40000 MHz | 37000 MHz-40000 MHz | TDD |
| n260 | 37000 MHz-40000 MHz | 37000 MHz-40000 MHz | FDD |
| n261 | 27500 MHz-28350 MHz | 27500 MHz-28350 MHz | FDD |

### <6G System General>

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 4 shows the requirements of the 6G system.

TABLE 5

| | |
|---|---|
| Per device peak data rate | 1 Tbps |
| E2E latency | 1 ms |
| Maximum spectral efficiency | 100 bps/Hz |
| Mobility support | Up to 1000 km/hr |
| Satellite integration | Fully |
| AI | Fully |
| Autonomous vehicle | Fully |
| XR | Fully |
| Haptic Communication | Fully |

The 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

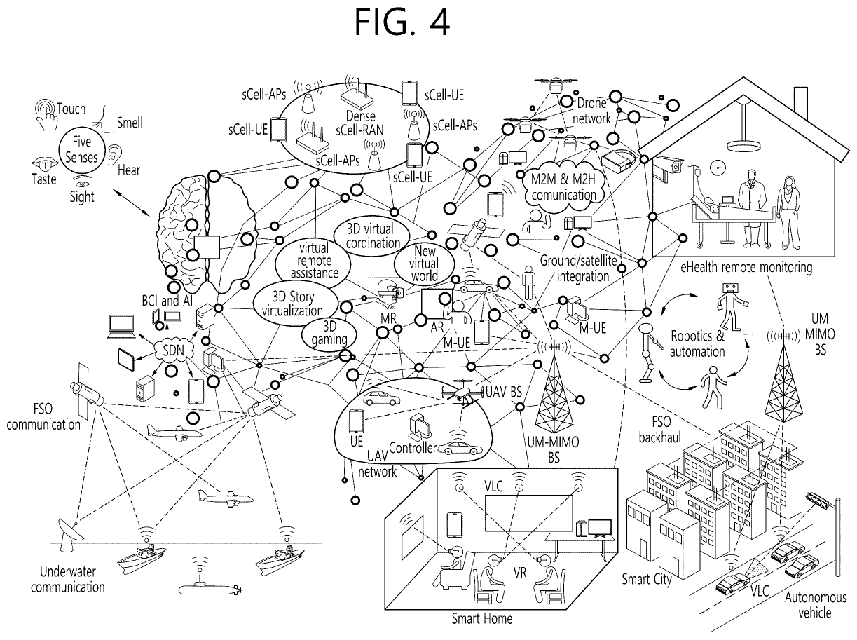

FIG. 4 is a diagram showing an example of a communication structure that can be provided in a 6G system.

The 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimension connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduces costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

### <Core Implementation Technology of 6G System>

### Artificial Intelligence

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

Machine learning refers to a series of operations to train a machine in order to create a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method, a recurrent Boltzmman machine (RNN) method and a spiking neural network (SNN). Such a learning model is applicable.

### THz (Terahertz) Communication

A data rate may increase by increasing bandwidth. This may be performed by using sub-TH communication with wide bandwidth and applying advanced massive MIMO technology. THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

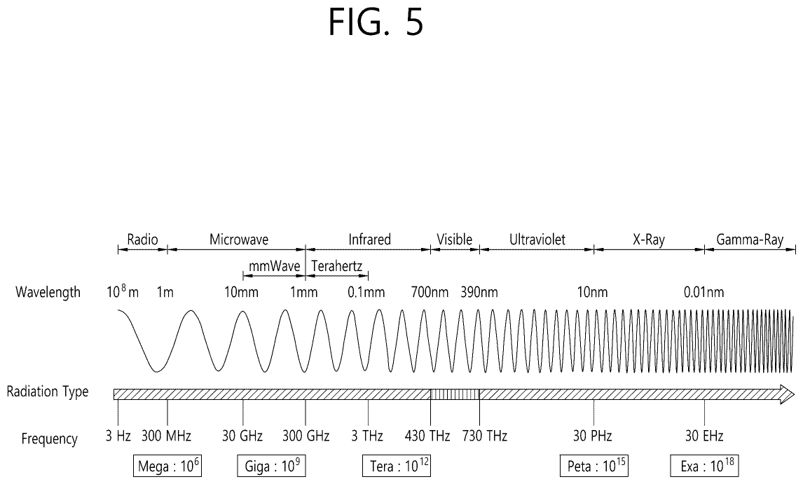

FIG. 5 shows an example of an electromagnetic spectrum.

The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### Large-Scale MIMO

One of core technologies for improving spectrum efficiency is MIMO technology. When MIMO technology is improved, spectrum efficiency is also improved. Accordingly, massive MIMO technology will be important in the 6G system. Since MIMO technology uses multiple paths, multiplexing technology and beam generation and management technology suitable for the THz band should be significantly considered such that data signals are transmitted through one or more paths.

### Hologram Beamforming

Beamforming is a signal processing procedure that adjusts an antenna array to transmit radio signals in a specific direction. This is a subset of smart antennas or advanced antenna systems. Beamforming technology has several advantages, such as high signal-to-noise ratio, interference prevention and rejection, and high network efficiency. Hologram Beamforming (HBF) is a new beamforming method that differs significantly from MIMO systems because this uses a software-defined antenna. HBF will be a very effective approach for efficient and flexible transmission and reception of signals in multi-antenna communication devices in 6G.

### Optical Wireless Technology

Optical wireless communication (OWC) is a form of optical communication that uses visible light, infrared light (IR), or ultraviolet light (UV) to carry signals. OWC operating in the visible light band (e.g., 390 to 750 nm) is commonly referred to as visible light communication (VLC). VLC implementations can utilize light-emitting diodes (LEDs). VLC can be used in a variety of applications, including wireless local area networks, wireless personal area networks, and vehicular networks.

VLC has several advantages over RF-based technologies. First, the spectrum occupied by VLC is free/unlicensed and can provide extensive bandwidth (THz-level bandwidth). Second, VLC rarely causes significant interference to other electromagnetic devices; therefore, VLC can be applied in sensitive electromagnetic interference applications such as aircraft and hospitals. Third, VLC has strengths in communication security and privacy. The transmission medium of VLC-based networks, namely visible light, cannot pass through walls and other opaque obstacles. Therefore, the transmission range of VLC can be limited to indoors, which can protect users' privacy and sensitive information. Fourth, VLC can use any light source as a base station, eliminating the need for expensive base stations.

Free-space optical communication (FSO) is an optical communication technology that uses light propagating in free space, such as air, outer space, and vacuum, to wirelessly transmit data for telecommunications or computer networking. FSO can be used as a point-to-point OWC system on the ground. FSO can operate in the near-infrared frequency (750-1600 nm). Laser transmitters may be used in FSO implementations, and FSO can provide high data rates (e.g., 10 Gbit/s), providing a potential solution to backhaul bottlenecks.

These OWC technologies are planned for 6G communications in addition to RF-based communications for all possible device-to-access networks. These networks will access network-to-backhaul/fronthaul network connections. OWC technology has already been in use since 4G communication systems, but will be more widely used to meet the needs of 6G communication systems. OWC technologies such as light fidelity, visible light communication, optical camera communication, and FSO communication based on optical bands are already well-known technologies. Communication based on optical wireless technology can provide extremely high data rates, low latency, and secure communication.

Light Detection And Ranging (LiDAR) is also based on the optical band and can be utilized in 6G communications for ultra-high resolution 3D mapping. LiDAR is a remote sensing method that uses near-infrared, visible, and ultraviolet light to illuminate an object, and the reflected light is detected by a light sensor to measure distance. LiDAR can be used for fully automated driving of cars.

### FSO Backhaul Network

The characteristics of the transmitter and receiver of the FSO system are similar to those of an optical fiber network. Accordingly, data transmission of the FSO system is similar to that of the optical fiber system. Accordingly, FSO may be a good technology for providing backhaul connection in the 6G system along with the optical fiber network. When FSO is used, very long-distance communication is possible even at a distance of 10,000 km or more. FSO supports mass backhaul connections for remote and non-remote areas such as sea, space, underwater and isolated islands. FSO also supports cellular base station connections.

### Non-Terrestrial Networks (NTN)

The 6G system will integrate terrestrial and aerial networks to support vertically expanding user communications. 3D BS will be delivered via low-orbit satellites and UAVs. Adding a new dimension in terms of altitude and associated degrees of freedom makes 3D connectivity quite different from traditional 2D networks. NR considers Non-Terrestrial Networks (NTNs) as one way to accomplish this. An NTN is a network or network segment that uses RF resources aboard a satellite (or UAS platform). There are two common scenarios for NTNs that provide access to user equipment: transparent payloads and regenerative payloads. The following are the basic elements of an NTN.
One or more sat-gateways that connect the NTN to the public data network.
GEO satellites are fed by one or several satellite gateways deployed across the satellite target range (e.g., regional or continental coverage). We assume that the UEs in a cell are served by only one sat-gateway.
Non-GEO satellites that are continuously serviced by one or multiple satellite gateways at a time. The system ensures service and feeder link continuity between successively serviced satellite gateways with a time duration sufficient to allow for mobility anchoring and handover.
The feeder link or radio link between the satellite gateway and the satellite (or UAS platform).
The service link or radio link between the user equipment and the satellite (or UAS platform).
A satellite (or UAS platform) that can implement transparent or regenerative (with onboard processing) payloads. Satellite (or UAS platform) generated beams typically produce multiple beams for a given service area, depending on the field of view. The footprint of the beam is typically elliptical. The field of view of the satellite (or UAS platform) depends on the onboard antenna diagram and the minimum angle of attack.
Transparent payload: Radio frequency filtering, frequency conversion, and amplification, so the waveform signal repeated by the payload is unchanged.
Regenerative payload: radio frequency filtering, frequency conversion and amplification, demodulation/decryption, switching and/or routing, and coding/modulation. This is effectively the same as having all or part of the base station functions (e.g., gNB) on board a satellite (or UAS platform).
For satellite deployments, optionally an inter-satellite link (ISL). This requires a regenerative payload on the satellite. ISLs can operate at RF frequencies or in the optical band.
User equipment is served by satellites (or UAS platforms) within the targeted coverage area.

Typically, GEO satellites and UAS are used to provide continental, regional, or local services.

Typically, constellations in LEO and MEO are used to provide coverage in both the Northern and Southern Hemispheres. In some cases, constellations can also provide global coverage, including polar regions. The latter requires proper orbital inclination, sufficient beams generated, and links between satellites.

### Quantum Communication

Quantum communication is a next-generation communication technology that can overcome the limitations of conventional communication such as security and high-speed computation by applying quantum mechanical properties to the field of information and communication. Quantum communication provides a means of generating, transmitting, processing, and storing information that cannot be expressed in the form of 0s and 1s according to the binary bit information used in existing communication technologies. In conventional communication technologies, wavelengths or amplitudes are used to transmit information between the transmitting and receiving ends, but in quantum communication, photons, the smallest unit of light, are used to transmit information between the transmitting and receiving ends. In particular, in the case of quantum communication, quantum uncertainty and quantum irreversibility can be used for the polarization or phase difference of photons (light), so quantum communication has the characteristic of being able to communicate with perfect security. In addition, quantum communication can also enable ultra-high-speed communication using quantum entanglement under certain conditions.

### Cell-Free Communication

Tight integration of multiple frequencies and heterogeneous communication technologies is critical in 6G systems. As a result, users can seamlessly move from one network to another without having to create any manual configurations on their devices. The best network is automatically selected from the available communication technologies. This will break the limitations of the cell concept in wireless communication. Currently, user movement from one cell to another causes too many handovers in dense networks, resulting in handover failures, handover delays, data loss, and ping-pong effects. 6G cell-free communication will overcome all this and provide better QoS.

Cell-free communication is defined as “a system in which a large number of geographically distributed antennas (APs) cooperatively serve a small number of terminals using the same time/frequency resources with the help of a fronthaul network and a CPU”. A single terminal is served by a set of multiple APs, which is called an AP cluster. There are several ways to form AP clusters, among which the method of configuring AP clusters with APs that can significantly contribute to improving the reception performance of the terminal is called the terminal-centered clustering method, and when using this method, the configuration is dynamically updated as the terminal moves. By adopting this device-centric AP clustering technique, the device is always at the center of the AP cluster and is therefore free from inter-cluster interference that can occur when the device is located at the boundary of the AP cluster. This cell-free communication will be achieved through multi-connectivity and multi-tier hybrid technologies and different heterogeneous radios in the device.

### Integration of Wireless Information and Energy Transfer (WIET)

WIET uses the same field and wave as a wireless communication system. In particular, a sensor and a smartphone will be charged using wireless power transfer during communication. WIET is a promising technology for extending the life of battery charging wireless systems. Therefore, devices without batteries will be supported in 6G communication.

### Integration of Wireless Communication and Sensing

An autonomous wireless network is a function for continuously detecting a dynamically changing environment state and exchanging information between different nodes. In 6G, sensing will be tightly integrated with communication to support autonomous systems.

### Integrated Access and Backhaul Network

In 6G, the density of access networks will be enormous. Each access network is connected by optical fiber and backhaul connection such as FSO network. To cope with a very large number of access networks, there will be a tight integration between the access and backhaul networks.

### Big Data Analysis

Big data analysis is a complex process for analyzing various large data sets or big data. This process finds information such as hidden data, unknown correlations, and customer disposition to ensure complete data management. Big data is collected from various sources such as video, social networks, images and sensors. This technology is widely used for processing massive data in the 6G system.

### Reconfigurable Intelligent Surface

There is a large body of research that considers the radio environment as a variable to be optimized along with the transmitter and receiver. The radio environment created by this approach is referred to as a Smart Radio Environment (SRE) or Intelligent Radio Environment (IRE) to highlight its fundamental differences from past design and optimization criteria. Various terms have been proposed for the reconfigurable intelligent antenna (or intelligent reconfigurable antenna technology) technology that enables SRE, including Reconfigurable Metasurfaces, Smart Large Intelligent Surfaces (SLIS), Large Intelligent Surfaces (LIS), Reconfigurable Intelligent Surface (RIS), and Intelligent Reflecting Surface (IRS).

In the case of THz band signals, there are many shadowed areas caused by obstacles due to the strong straightness of the signal, and RIS technology is important to expand the communication area by installing RIS near these shadowed areas, strengthening communication stability and enabling additional value-added services. RIS is an artificial surface made of electromagnetic materials that can alter the propagation of incoming and outgoing radio waves. While RIS can be seen as an extension of massive MIMO, it has a different array structure and operating mechanism than massive MIMO. RIS also has the advantage of lower power consumption because it operates as a reconfigurable reflector with passive elements, meaning it only passively reflects the signal without using an active RF chain. In addition, each of the passive reflectors in the RIS must independently adjust the phase shift of the incident signal, which can be advantageous for wireless communication channels. By properly adjusting the phase shift through the RIS controller, the reflected signal can be gathered at the target receiver to boost the received signal power.

In addition to reflecting radio signals, there are also RISs that can adjust transmission and refraction properties, and these RISs are mainly used for O2I (Outdoor to Indoor). Recently, STAR-RIS (Simultaneous Transmission and Reflection RIS), which provides transmission while reflecting, has also been actively researched.

### Metaverse

Metaverse is a portmanteau of the words “meta” meaning virtual, transcendent, and “universe” meaning space. Generally speaking, the metaverse is a three-dimensional virtual space where the same social and economic activities as in the real world are commonplace.

Extended Reality (XR), a key technology enabling the Metaverse, is the fusion of the virtual and the real, which can extend the experience of reality and provide a unique sense of immersion. The high bandwidth and low latency of 6G networks will enable users to experience more immersive virtual reality (VR) and augmented reality (AR) experiences.

### Autonomous Driving, Self-driving

For perfect autonomous driving, vehicles must communicate with each other to inform each other of dangerous situations, or with infrastructure such as parking lots and traffic lights to check information such as the location of parking information and signal change times. Vehicle-to-Everything (V2X), a key element in building an autonomous driving infrastructure, is a technology that enables vehicles to communicate and share information with various elements on the road, such as vehicle-to-vehicle (V2V) and vehicle-to-infrastructure (V2I), for autonomous driving.

In order to maximize the performance of autonomous driving and ensure high safety, fast transmission speeds and low latency technologies are essential. In addition, in the future, autonomous driving will go beyond delivering warnings and guidance messages to the driver to actively intervene in vehicle operation and directly control the vehicle in dangerous situations, and the amount of information that needs to be transmitted and received will be enormous, so 6G is expected to maximize autonomous driving with faster transmission speeds and lower latency than 5G.

### Unmanned Aerial Vehicle (UAV)

An unmanned aerial vehicle (UAV) or drone will be an important factor in 6G wireless communication. In most cases, a high-speed data wireless connection is provided using UAV technology. A base station entity is installed in the UAV to provide cellular connectivity. UAVs have certain features, which are not found in fixed base station infrastructures, such as easy deployment, strong line-of-sight links, and mobility-controlled degrees of freedom. During emergencies such as natural disasters, the deployment of terrestrial telecommunications infrastructure is not economically feasible and sometimes services cannot be provided in volatile environments. The UAV can easily handle this situation. The UAV will be a new paradigm in the field of wireless communications. This technology facilitates the three basic requirements of wireless networks, such as eMBB, URLLC and mMTC. The UAV can also serve a number of purposes, such as network connectivity improvement, fire detection, disaster emergency services, security and surveillance, pollution monitoring, parking monitoring, and accident monitoring. Therefore, UAV technology is recognized as one of the most important technologies for 6G communication.

### Block-Chain

A blockchain will be important technology for managing large amounts of data in future communication systems. The blockchain is a form of distributed ledger technology, and distributed ledger is a database distributed across numerous nodes or computing devices. Each node duplicates and stores the same copy of the ledger. The blockchain is managed through a peer-to-peer (P2P) network. This may exist without being managed by a centralized institution or server. Blockchain data is collected together and organized into blocks. The blocks are connected to each other and protected using encryption. The blockchain completely complements large-scale IoT through improved interoperability, security, privacy, stability and scalability. Accordingly, the blockchain technology provides several functions such as interoperability between devices, high-capacity data traceability, autonomous interaction of different IoT systems, and large-scale connection stability of 6G communication systems.

### <Random Access Channel (RACH) Procedure>

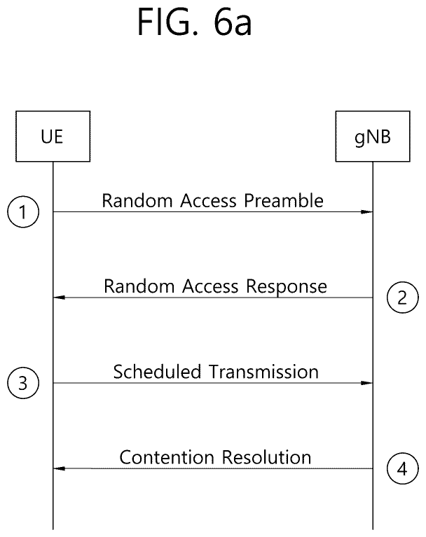

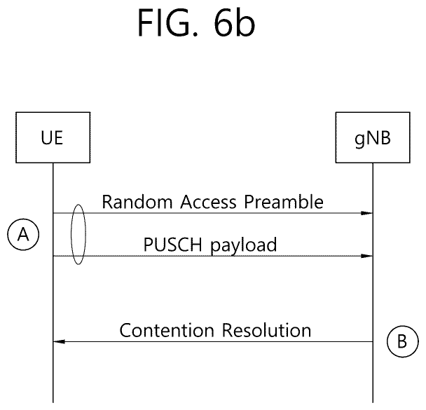

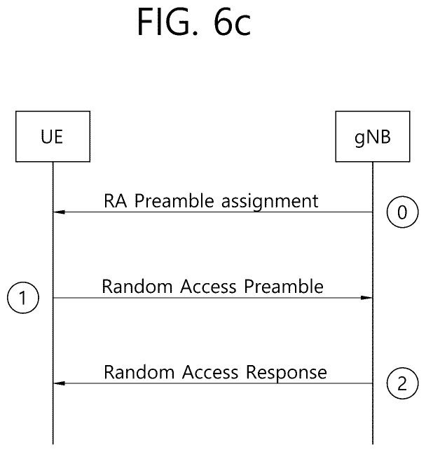

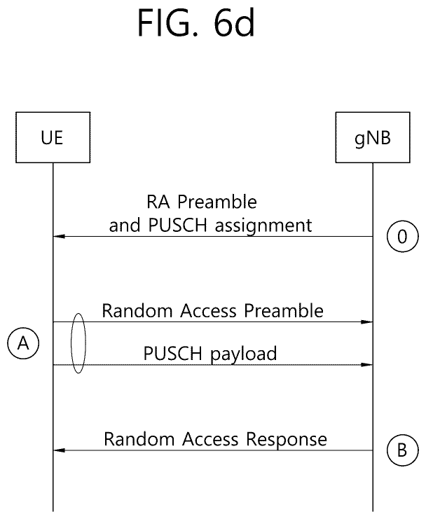

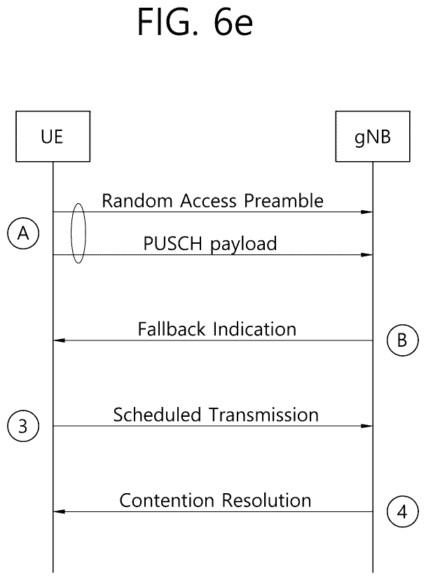

FIGS. 6a through 6e shows an example of RACH procedures applicable to an embodiment of the present disclosure.

Referring to FIGS. 6a through 6e, a RACH procedure is described, according to one embodiment of the present disclosure. The embodiments of FIGS. 6a through 6e may be combined with various embodiments of the present disclosure.

In one embodiment of the disclosure, where RF requirements (e.g., Tx RF performance requirements and/or Rx RF performance requirements) are described, the UE may satisfy those RF requirements. For example, a UE may be tested to satisfy RF requirements (e.g., Tx RF performance requirements and/or Rx Rf performance requirements) according to one embodiment of the disclosure. In one embodiment of the disclosure, a UE that meets these RF requirements may perform the RACH procedure. When the UE transmits messages, data, signaling, etc. to the gNB, the UE satisfies the Tx RF performance requirements described in the first embodiment of this specification. When the UE receives messages, data, signaling, etc. from the gNB, the UE satisfies the Rx RF performance requirements described in the first embodiment of this specification.

To connect the UE to the 5G network, the UE and the 5G network must synchronize in the uplink and downlink. Downlink synchronization is performed when the UE successfully decodes the SSB transmitted by the gNB. To establish the uplink synchronization and RRC connection, the UE shall perform the RACH random access procedure.

Two types of random access procedures are supported. The two types of random access procedures include a four-stage Random Access (RA) type using MSG1 and a two-stage RA type using MSGA.

The two types of RA procedures can support Contention Based Random Access (CBRA) and Contention Free Random Access (CFRA), as shown in FIG. 6a through FIG. 6e below, respectively. The UE may select the random access type at the beginning of the random access procedure, depending on the network configuration.

Referring to FIG. 6a and FIG. 6c, a four-stage RA type using MSG1 is illustrated.

Step 4 The MSG1 of RA type contains the preamble of the PRACH. The UE transmits the MSG1. After the UE sends the MSG1, the UE monitors the network for a response within the set window.

For CBRA according to the example of FIG. 6a, when the UE receives a random access response (MSG2) from the gNB, the UE may transmit MSG3 using the UL grant scheduled by the response message. The UE may then monitor the contention resolution. If contention resolution is not successful after the MSG3 (re)transmission, the UE shall perform the MSG1 transmission again.

For CFRA according to the example in FIG. 6c, a dedicated preamble for MSG1 transmission is allocated by the network. The gNB sends the RA preamble assignment to the UE. The UE transmits an MSG1 containing the random access preamble to the gNB. Upon receiving the random access response from the network, the UE terminates the random access procedure.

Referring to FIGS. 6b, 6d, and 6e, a two-stage RA type is described. The MSGA of the two-stage RA type includes a random access preamble on the PRACH and a PUSCH payload. After the UE transmits the MSGA, the UE monitors the response from the network within a set window.

For CBRA according to the example of FIG. 6b, after the UE receives the network response (e.g., MSGB), if the contention resolution is successful, the UE terminates the random access procedure. If the fallback indication is received within the MSGB, the UE performs the MSG3 transmission using the UL grant scheduled in the fallback indication and monitors the contention resolution, as shown in FIG. 6e. If contention resolution is not successful after the MSG3 (re)transmission, the UE shall perform the MSGA transmission again.

In the case of CFRA according to the example of FIG. 6d, the UE may receive RA preamble allocation and PUSCH allocation from the gNB. Dedicated preamble and PUSCH resources may then be set up for MSGA transmission. The UE transmits the MSGA. When the UE receives a network response, the UE terminates the random access procedure.

If the random access procedure of the two-stage RA type is not completed after several MSGA transmissions, the UE may be set to switch to the CBRA of the four-stage RA type.

### The Present Disclosure of the Present Specification

In prior arts, requirements related to power class 1.5 UE, which is configured with inter-band CA were not defined. Therefore, the UE cannot perform communication based on the inter-band CA.

Examples of the present disclosure are related to how to configure the transmitted power for power class 1.5(29 dBm) UE supporting a NR uplink inter band Carrier Aggregation (CA).

The UE may indicate the capability information to a network(NW) (e.g., a base station) and power class of the UE together. For example, the UE may transmit capability information to the NW. For example, the capability information may include the power class of the UE and information that the UE supports Uplink Multiple-input and multiple-output (UL MIMO), maximum uplink duty cycle, and/or inter-band CA. For example, the capability information may include power class capability(e.g., power class per band, or power class per band combination). If the UE support UL MIMO, the capability information may include uplink full power mode capability (e.g., Mode-full, Mode-1, Mode-2 . . . ) If the UE support Tx diversity, the capability information may include the tx diversity capability.

The NW may transmit information of the allowed UE power(for example, p-Max), band information, modulation order, and others to the UE. Then, the UE may configure transmission power based on the information (e.g., p-Max, band, modulation order, and others). The UE may transmit signal based on the transmission power. And, the UE may report the configured transmission power and the power headroom (PH) to the NW. The power headroom may refer to the amount of remaining power available for transmission that the UE has before reaching its maximum transmit power limit.

In the prior arts, the UE capability signals related to power class are defined in TS38.306 V17.3.0 as follows:

### Power Capability Per Band:

ue-PowerClass,
ue-PowerClass-V1610,
ue-PowerClass-v1700

### Capability of Power Class Per Band Combination:

powerClass-v1530,
powerClass-v1610,
powerClassNRPart-r16,
intraBandPowerClass-r16,
ue-CA-PowerClass-N (E-UTRA power),
higherPowerLimit-r17,

### Capability of Power Capability Per Feature Set(FS):

ue-PowerClassPerBandPerBC-r17.

Here, the feature set can be configured based on band combination.

And, the UE capability signals related to maximum uplink duty cycle are defined in TS38.306 as follows. The UE may transmit information related to maximum uplink duty cycle to the NW (e.g., base station)

### Capability of Uplink Duty Cycle Capability Per Band:

maxUplinkDutyCycle-PC2-FR1,
maxUplinkDutyCycle-PC1dot5-MPE-FR1-r16,
maxUplinkDutyCycle-FR2.

### Capability of Uplink Duty Cycle Capability Per Band Combination:

maxUplinkDutyCycle-interBandCA-PC2-r17 (FR1 only),
maxUplinkDutyCycle-SULcombination-PC2-r17.

For uplink inter band CA, UE Radio Frequency (RF) requirements were specified for both power class 3(PC3) and power class 2(PC2). Here, PC2 and PC3 may mean maximum output power of 23 dBm and 26 dBm respectively. For example, UE Power Classes define the maximum output power for any transmission bandwidth within the channel bandwidth of NR carrier.

For PC2 UE supporting the uplink inter band CA, the UE RF requirements were specified based on considering the capabilities of power class and uplink duty cycle as follows.
ue-PowerClass/powerClass/ue-PowerClassPerBandPerBC-r17/higherPowerLimit
maxUplinkDutyCycle-PC2-FR1/maxUplinkDutyCycle-interBandCA-PC2-r17

The UE may support power class 1.5 and uplink inter-band CA. For uplink inter band CA with PC1.5, the following band combination is assumed as examples for explanation in the present disclosure.
CApower class may be PC1.5
CA_n1A-n78A may be configured. NR operating band n1 (PC3 FDD 1Tx) and n78 (PC1.5 TDD 2Tx: UL MIMO or Tx diversity) are used. In the present disclosure, n1 (PC3 FDD 1Tx) and n78 (PC1.5 TDD 2Tx: UL MIMO or Tx diversity) may mean that CA combination is based on band n1 and band n78. FDD is used for band n1 and TDD is used for band n78. n1 (PC3 FDD 1Tx) also means that band n1 is supported by power class 3 based on one 23 dBm Power Amplifier (PA). n78 (PC1.5 TDD 2Tx: UL MIMO or Tx diversity) also means that band n78 is supported by power class 1.5 based on two 26 dBm PAs, UL MIMO is supported, or Tx diversity is supported. CA power class for CA_n1A-n78A may be power class 1.5 which supports 29 dBm maximum output, based on NR operating band n1 (PC3 FDD 1Tx) and n78 (PC1.5 TDD 2Tx: UL MIMO or Tx diversity).

TABLE 6

| | Uplink (UL) operating | Downlink (DL) | |
|---|---|---|---|
| NR | band | operating band | Duple |
| operating | BS receive/UE transmit | BS transmit/UE receive | × |
| band | F_{UL}_low-F_{UL}_high | F_{DL}_low-F_{DL}_high | Mode |
| n1 | 1920 MHz-1980 MHz | 2110 MHz-2170 MHz | FDD |
| n78 | 3300 MHz-3800 MHz | 3300 MHz-3800 MHz | TDD |

Table 6 shows examples of NR operating bands in FR1.

Here, ‘A’ means one of NR CA bandwidth classes in Table 7 (corresponds to Table 5.3A.5-1 in TS38.101-1 V18.0.0).

TABLE 7

| NR CA | | Number of | |
|---|---|---|---|
| bandwidth | Aggregated | contiguous | Fallback |
| class | channel bandwidth | CC | group |
| A | BW_{Channel ≤} BW_{Channel,max} | 1 | 1, 2, 3 |
| | | | (NOTE |
| | | | 4 applied) |
| B | 20 MHz ≤ BW_{Channel}_CA ≤ | 2 | 2, 3 |
| | 100 MHz | | ^{(NOTE 4} |
| | | | applied) |
| C | 100 MHz < BW_{Channel}_CA ≤ 2 × | 2 | 1, 3 |
| | BW_{Channel,max} | | ^{(NOTE 4} |
| | | | applied) |
| D | 200 MHz < BW_{Channel}_CA ≤ 3 × | 3 | |
| | BW_{Channel,max} | | |
| E | 300 MHz < BW_{Channel}_CA ≤ 4 × | 4 | |
| | BW_{Channel,max} | | |
| G | 100 MHz < BW_{Channel}_CA ≤ 150 | 3 | 2 |
| | MHz | | |
| H | 150 MHz < BW_{Channel}_CA ≤ 200 | 4 | |
| | MHz | | |
| I | 200 MHz < BW_{Channel}_CA ≤ 250 | 5 | |
| | MHz | | |
| J | 250 MHz < BW_{Channel}_CA ≤ 300 | 6 | |
| | MHz | | |
| K | 300 MHz < BW_{Channel}_CA ≤ 350 | 7 | |
| | MHz | | |
| L | 350 MHz < BW_{Channel}_CA ≤ 400 | 8 | |
| | MHz | | |
| M^{(NOTE 3 applied)} | 50 MHz ≤ BW_{Channel}_CA ≤ | 3 | 3 |
| | 200 MHz | | ^{(NOTE 4} |
| N^{(NOTE 3 applied)} | 80 MHz ≤ BW_{Channel}_CA ≤ | 4 | applied) |
| | 300 MHz | | |
| O^{(NOTE 3 applied)} | 100 MHz ≤ BW_{Channel}_CA ≤ | 5 | |
| | 400 MHz | | |

^{NOTE 1}: BW_{Channel, max} is maximum channel bandwidth supported among all bands
^{NOTE 2}: It is mandatory for a UE to be able to fallback to lower order NR CA bandwidth class configuration within a fallback group. It is not mandatory for a UE to be able to fallback to lower order NR CA bandwidth class configuration that belong to a different fallback group.
^{NOTE 3}: This bandwidth class is only applicable to bands identified for use with shared spectrum channel access in Table 5.2-1 of TS 38.101-1.
^{NOTE 4}: Fallback group 3 is only applicable to bands identified for use with shared spectrum channel access in Table 5.2-1 of TS 38.101-1.

Table 7 shows NR CA bandwidth classes.

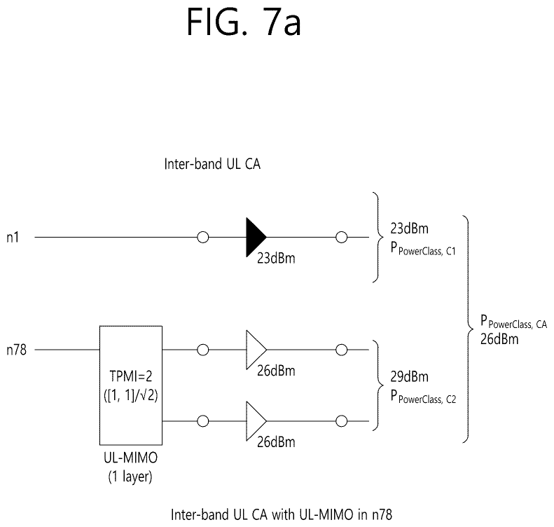

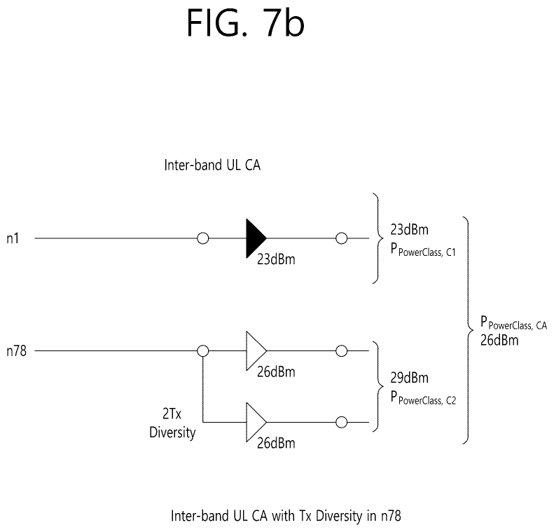

FIGS. 7a and 7b shows the example of Tx RF architecture of PC1.5 UE for supporting CA_n1A-n78A.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIGS. 7a and 7b illustrate an example of Tx RF architecture according to an embodiment of the present disclosure.

FIGS. 7a and 7b shows the example of Tx RF architecture of PC1.5 UE for supporting CA_n1A-n78A. As shown in FIGS. 7a and 7b, maximum output power for band n1 may be 23 dBm. Maximum output power for band n78 may be 23 dBm. P_{PowerClas,C1} may mean output power for Component Carrier (CC)1, PPowerClas,C2 may mean output power for CC2, P_{PowerClas,CA} may mean total output power for CA based on band n1 and band n78.

FIG. 7a is for UL-MIMO in n78 and FIG. 7b is for Tx diversity in n78. For example, FIG. 7a shows an example of Tx RF architecture for inter-band UL CA with UL-MIMO in band n78. For example, FIG. 7b shows an example of Tx RF architecture for inter-band UL CA with TxDiversity in band n78.

Examples of architectures in FIGS. 7a and 7b may be used for explaining examples of the present disclosure.

Based on the examples of PC1.5 UE RF architecture, to support uplink inter band CA UE, a new capability of maximum uplink duty cycle may be defined. According to the present disclosure, the following UE capability related to maximum uplink duty cycle is proposed:
maxUplinkDutyCycle-interBandCA-PC1dot5-r18. This capability may be indicated per Band Combination (BC). Value for this capability may be 10%, 15%, 20%, 25%, 30%, 40%, 50%, 60%, 70%, 80%, 90%, 100%.

Here, the UE capability(e.g., maxUplinkDutyCycle-interBandCA-PC1dot5-r18) related to maximum uplink duty cycle may be used by a UE to indicate the maximum average percentage of symbols during a certain evaluation period. For example, the maximum average percentage of symbols may be scheduled for uplink transmission so as to ensure compliance with applicable electromagnetic energy absorption requirements provided by regulatory bodies (e.g., SAR(Specific. Absorption Rate) and/or MPE(Maximum permissible Exposure)).

According to the present disclosure, for this PC1.5 UE, a supported power class may be different depending on the indicated Information Element (IE) p-max(s), uplink duty cycle(s) and actual percentage of uplink symbols. p-max may refer to maximum transmit power allowed in a serving cell.

The NW (e.g., base station) may transmit information related to p-Max to a UE. The information may be based on the following:
p-Max (it corresponds to P_{EMAX,C} in [UE configured transmission power for uplink inter band CA]),
p-NR-FR1 or p-UE-FR1 (it corresponds to P_{EMAX,CA} in [UE configured transmission power for uplink inter band CA]). p-NR-FR1 may mean the maximum total transmit power to be used by the UE in this NR cell group across all serving cells in frequency range 1 (FR1). p-UE-FR1 may mean the maximum total transmit power to be used by the UE across all serving cells in frequency range 1 (FR1) across all cell groups. P_{EMAX,CA} is the value indicated by p-NR-FR1 or by p-UE-FR1 whichever is the smallest if both are present.

Hereinafter, examples of the present disclosure are explained based on examples related to case 1 and case 2. Case 1 in the present disclosure may include examples using new signaling ‘maxUplinkDutyCycle-interBandCA-PC1dot5-r18’. Case 2 in the present disclosure may include examples using existing signaling (e.g., maxUplinkDutyCycle-interBandCA-PC2-r17(=Z1)).

### [Case 1: UE Maximum Output Power for Inter-Band UL CA]

For inter-band uplink carrier aggregation with uplink assigned to two NR bands, UE maximum output power shall be measured over all component carriers from different bands. If each band has separate antenna connectors, maximum output power may be defined as the sum of maximum output power from each UE antenna connector. The period of measurement shall be at least one sub frame (1 ms).

Here, the maximum output power may be specified as power class 1.5 for CA PC1.5 supporting CA_n1A-n78A.

If a UE supports a power class different from the default UE power class for the band combination and the supported power class enables maximum output power higher than that of the default power class(=power class 3), the following may be applied:
a1) if the field of UE capability maxUplinkDutyCycle-interBandCA-PC2-r17 is absent and the field of UE capability maxUplinkDutyCycle-interBandCA-PC1dot5-r18 is absent and if the IE P-Max as defined in TS 38.331 is provided and set to the maximum output power of the default power class or lower; or
a2) if the field of UE capability maxUplinkDutyCycle-interBandCA-PC2-r17 is not absent and the average percentage of uplink symbols transmitted in a certain evaluation period is larger than maxUplinkDutyCycle-interBandCA-PC2-r17 (The exact evaluation period is no less than one radio frame); or
a3) if the field of UE capability maxUplinkDutyCycle-interBandCA-PC1dot5-r18 is not absent and half the average percentage of uplink symbols transmitted in a certain evaluation period is larger than maxUplinkDutyCycle-interBandCA-PC1dot5-r18 (The exact evaluation period is no less than one radio frame); or
a4) if the IE P-Max as defined in TS 38.331 V17.3.0 is provided and set to the maximum output power of the default power class or lower;
A) (e.g., one of the above a1 to a4 is satisfied), shall apply all requirements for the default power class (e.g., PC3) to the supported power class [Case1: UE configured transmission power for uplink inter band CA];
c0) else if the UE does not support a power class with higher maximum output power than PC2; or
c1) if the field of UE capability maxUplinkDutyCycle-interBandCA-PC2-r17 is absent and the field of UE capability maxUplinkDutyCycle-interBandCA-PC1dot5-r18 is absent and if the IE P-Max as defined in TS 38.331 is provided and set to the maximum output power of the power class 2 or lower; or
c2) if the field of UE capability maxUplinkDutyCycle-interBandCA-PC2-r17 is not absent and the average percentage of uplink symbols transmitted in a certain evaluation period is larger than 0.5*maxUplinkDutyCycle-interBandCA-PC2-r17 (The exact evaluation period is no less than one radio frame); or
c3) if the field of UE capability maxUplinkDutyCycle-interBandCA-PC1dot5-r18 is not absent and the average percentage of uplink symbols transmitted in a certain evaluation period is larger than maxUplinkDutyCycle-interBandCA-PC1dot5-r18 (The exact evaluation period is no less than one radio frame); or
c4) if the IE P-Max as defined in TS 38.331 is provided and set to the maximum output power of the power class 2 or lower;
C) (e.g., one of the above c1 to c4 is satisfied), shall apply all requirements for power class 2 to the supported power class and set the configured transmitted power as specified as Case1;
D) else, shall apply all requirements for the supported power class and set the configured transmitted power as specified as Case1;.

Here, if the field of UE capability maxUplinkDutyCycle-interBandCA-PC2-r17 is absent and the field of UE capability maxUplinkDutyCycle-interBandCA-PC1dot5-r18 is absent, the all requirements for the supported power class is regardless of the average percentage of uplink symbols) For example, regardless of the average percentage of uplink symbols, the UE may apply requirements for power class having smaller maximum out put power between the UE's CA power class and p-max from the NW.

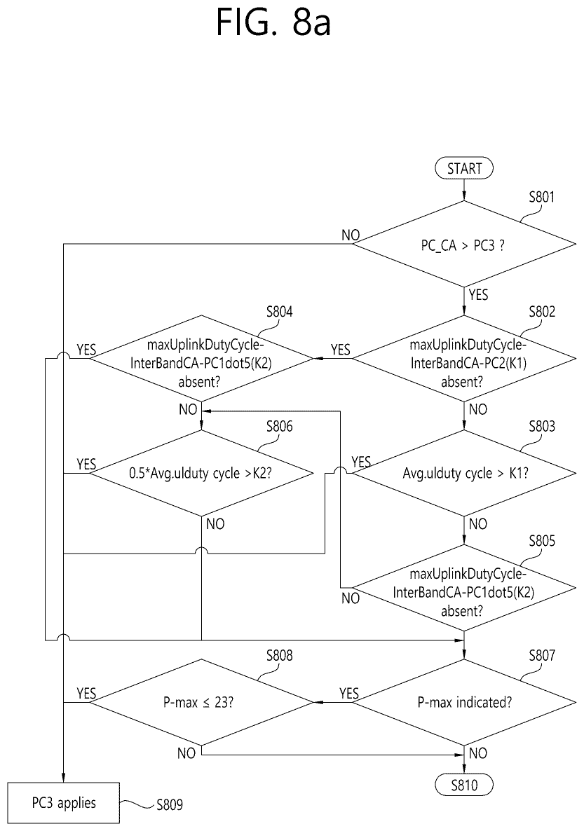

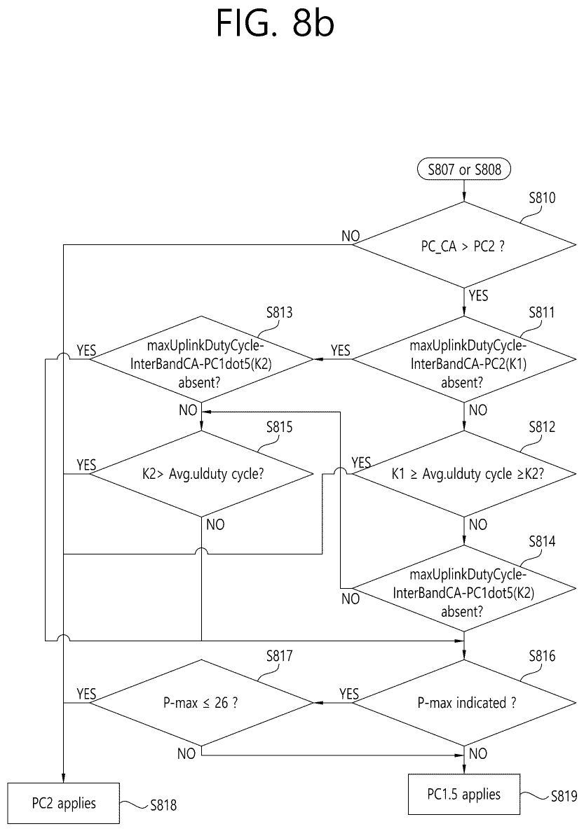

FIGS. 8a and 8b shows the flow chart of the supported maximum output power of CA power class. In this figure, ‘Avg.ulduty cycle’ is the actual scheduled uplink average duty cycle.

In the present disclosure, the UE may know the actual scheduled uplink average duty cycle based on that the NW transmit information related to UL scheduling per band to the UE. Note that the Avg of ‘Avg.ulduty cycle’ means actual scheduled averaged. The NW transmit UL scheduling to the UE, but when NACK occurs, the UE may not transmit UL signal on a slot related to NACK. The UE may calculate ‘Avg.ulduty cycle’ based on UL scheduling from the NW and slots used for actual UL transmission.

For reference, according to the present disclosure, requirements for certain power class (e.g., PC 1.5, PC 2, PC3) may include at least one of UE maximum output power, UE maximum output power reduction, UE additional maximum output power reduction, and/or Configured output power. For example, “applying requirements for PC X(e.g., X can be 1.5, 2, 3)” may mean that a UE applies requirements for PC X(e.g., X can be 1.5, 2, 3).

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIGS. 8a and 8b illustrate an example of a flow chart related to supported power class an operation according to an embodiment of the present disclosure.

FIGS. 8a and 8b show an example of flow chart of the supported power class of UL inter-band CA. The present disclosure is not limited to the flowchart of FIGS. 8a and 8b, the shown flowchart is merely an example to explain how requirements related to PC1.5, PC2, or PC3 are applied. For example, the UE applies requirements for PC1.5, PC2, or PC3 and set the corresponding configured transmitted power based on the examples of the present disclosure.

For reference, maxUplinkDutyCycle-InterBandCA-PC2 is an example of a capability information related to maximum uplink duty cycle for inter band CA for the power class 2. Maximum uplink duty cycle for inter band CA for the power class 2 ma refer to K1 in figures. maxUplinkDutyCycle-InterBandCA-PC1dot5 is an example of a capability information related to maximum uplink duty cycle for inter band CA for the power class 1.5. Maximum uplink duty cycle for inter band CA for the power class 1.5 may refer to K2 in figures. The UE may support UL MIMO.

Herein, the average percentage of uplink symbols (e.g., Avg.ulduty cycle) is based on the following equation:

$$Avg . ulduty cycle = 50 \% * ( {Duty}_{NR , x} / {maxDuty}_{NR , x} + {Duty}_{NR , y} / {maxDuty}_{NR , y} ) .$$

DUty_{NR,x} or DUty_{NR,y} may be maxUplinkDutyCycle-PC1dot5-MPE-FR1-r16 per band, or maxUplinkDutyCycle-PC2-FR1 per band. maxUplinkDutyCycle-PC2-FR1 per band may mean maximum duty cycle for PC2 per operating band maxUplinkDutyCycle-PC1dot5-MPE-FR1-r16 per band may mean maximum duty cycle for PC1.5 per operating band. In the present disclosure, MPE means Maximum. Permissible Emission.

In step S801, based on whether PC_CA is bigger than PC3 or not, S802 or S809 is applied. PC_CA being bigger than PC3 means power related to PC_CA is bigger than 23 dBm. If PC_CA is bigger than PC3, S802 applied. Otherwise, S809 is applied.

In step S802, based on whether maxUplinkDutyCycle-interBandCA-PC2-r17(K1) is absent or not, S804 or S803 is applied.

In step S803, based on whether Avg.ulduty cycle is bigger than K1 or not, S805 or S803 is applied.

In step S804, based on whether maxUplinkDutyCycle-interBandCA-PC1dot5-r18(K2) is absent or not, S806 or S807 is applied.

In step S805, based on whether maxUplinkDutyCycle-interBandCA-PC1dot5-r18(K2) is absent or not, S806 or S807 is applied.

In step S806, based on whether 0.5*Avg.ulduty cycle is bigger than K2, S809 or S807 is applied.

In step S807, based on whether P-max is indicated (e.g., whether the UE receives p-max from the NW) or not, S808 or S810 is applied.

In step S808, based on whether P-max is equal to or less than 23 dBm, or not, S809 or S810 is applied.

In step S809, PC3 applies. For example, requirements related to PC3 is applied for the UE.

In step S810, based on whether PC_CA is bigger than PC2 or not, S818 or S811 is applied.

In step S811, based on whether maxUplinkDutyCycle-interBandCA-PC2-r17(K1) is abesent or not, S812 or S813 is applied.

In step S812, based on whether 0.5*Avg.ulduty cycle is bigger than or equal to K1 and is 0.5*Avg.ulduty cycle is less than or equal to K1, S818 or S814 is applied.

In step S813, based on whether maxUplinkDutyCycle-interBandCA-PC1dot5-r17(K2) is abesent or not, S815 or S816 is applied.

In step S814, based on whether maxUplinkDutyCycle-interBandCA-PC1dot5-r17(K2) is abesent or not, S815 or S816 is applied.

In step S815, based on whether Avg.ulduty cycle is bigger than K2, S818 or S816 is applied.

In step S816, based on whether P-max is indicated (e.g., whether the UE receives p-max from the NW) or not, S817 or S819 is applied.

In step S817, based on whether P-max is equal to or less than 26 dBm, or not, S818 or S819 is applied.

In step S818, PC2 applies. For example, requirements related to PC2 is applied for the UE.

In step S819, PC1.5 applies. For example, requirements related to PC1.5 is applied for the UE.

The average percentage of uplink symbols may be specified as below and the capability(e.g., examples of capabilities in the following examples) may be applied to the CA combinations:

The average percentage of uplink symbols may be defined as 50%*(Duty_{NR,x}/maxDuty_{NR,x}+Duty_{NR,y}/maxDuty_{NR,y}). Duty_{NR,x}, Duty_{NR,y} represent (or, are related to) the actual percentage of uplink symbols transmitted in the same evaluation period (e.g., the exact evaluation period is no less than one radio frame) for NR Band x, NR Band y respectively. Each of maxDuty_{NR,x} and maxDuty_{NR,y} may represent (or, be related to) the field of UE capability maxUplinkDutyCycle-PC2-FR1 per band and/or the field of UE capability maxUplinkDutyCycle-PC1dot5-MPE-FR1-r16 per band. In the present disclosure, “-r16”, “-r17”, and “-r18” in the name of information can be deleted. Information having name without “-r16”, “-r17”, and “-r18” may used as the same information with “-r16”, “-r17”, and “-r18”.

For NR Bandx or NR Bandy, the following may be applied:
if power class of one or both of the bands within the band combination is power class 2 and the corresponding UE capability maxUplinkDutyCycle-PC2-FR1 is absent, the corresponding maxDuty_{NR,x} or maxDuty_{NR,y} may be equal to 50%;
else if the band is configured with power class 3, the corresponding maxDuty_{NR,x} or maxDuty_{NR,y} may be equal to 100%.
if power class of one or both of the bands within the band combination is power class 1.5 and the corresponding UE capability maxUplinkDutyCycle-PC1dot5-MPE-FR1-r16 is absent: the corresponding maxDuty_{NR,x} or maxDuty_{NR,y} is equal to 25%;
else if the band is configured with power class 2: the corresponding maxDuty_{NR,x} or maxDuty_{NR,y} is equal to 50%;
else if the band is configured with power class 3: the corresponding maxDuty_{NR,x} or maxDuty_{NR,y} is equal to 100%.

For CA power class 1.5 of CA_n1A-n78A in FIGS. 7a and 7b, NR Bandx may correspond to n1 and NR Bandy corresponds to n78. And, maxDuty_{NR,x} and maxDuty_{NR,y} are as follows.
maxDuty_{NR,x}=1000
maxDuty_{NR,y}=maxUplinkDutyCycle-PC1dot5-MPE-FR1-r16, if it(e.g., maxUplinkDutyCycle-PC1dot5-MPE-FR1-r16) is not absent. If it is absent, maxDuty_{NR,y}=25%.

If Duty_{NR,x}=50%, Duty_{NR,y}=10%, and maxUplinkDutyCycle-PC1dot5-MPE-FR1-r16 is indicated with 30%, the average duty percentage of transmission may be as the following. The average duty percentage of transmission=(50%*(50/100+10/30)=41.7%. Herein, denominator may be based on maxDutyNR,x=100% for band x, maxDutyNR,y=maxUplinkDutyCycle-PC1dot5-MPE-FR1-r16 (30%) for band y. Numerator may be based on Duty_{NR,x}=50% for band x, Duty_{NR,y}=10% for bandy.

If Duty_{NR,x}=50%, Duty_{NR,y}=10%, and maxUplinkDutyCycle-PC1dot5-MPE-FR1-r16 is absent, the maximum average duty percentage of transmission may be as the following. The average duty percentage of transmission=(50%*(50/100+10/25)=45%,

Here, the average duty percentage of transmission corresponds to Avg.ulduty cycle in FIGS. 8a and 8b.

### [Case 2: UE Maximum Output Power for Inter-Band UL CA]

The following options may be considered.
Option 1: Use 0.5*maxUplinkDutyCycle-interBandCA-PC2 if indicated as the threshold for PC1.5 UL duty cycle, below which PC1.5 requirements apply. Below which means, it is less than 0.5*maxUplinkDutyCycle-interBandCA-PC2. If absent, UE shall work on power class PC1.5 regardless of UL duty cycle and may use P-MPRc as defined in 6.2.4 in TS 38.101-1 V18.0.0 or other means if necessary.
Option 2: For PC1.5 band combination, SAR compliance with the possible new signaling for the duty cycle mechanism need to be further studied.
Option 3: Study whether the existing UE capabilities (PC2-related maxUplinkDutyCycle) can be applied or new UE capabilities are needed.

For discussion on which option is reasonable, we assume the following parameters.
Z1=maxUplinkDutyCycle-interBandCA-PC2 (threshold)
Z2=new_maxUplinkDutyCycle-interBandCA-PC1.5 (threshold)
X=average percentage of uplink symbols transmitted in a certain evaluation period

If a UE supports a different power class than the default UE power class for the band combination listed in Table 6.2A.1.3-1 in TS38.101-1 V18.0.0 and the supported power class enables the higher maximum output power than that of the default power class:
if the field of UE capability maxUplinkDutyCycle-interBandCA-PC2(=Z1) is not absent and the average percentage (=X) of uplink symbols transmitted in a certain evaluation period is larger than maxUplinkDutyCycle-interBandCA-PC2 as defined in TS 38.331 (The exact evaluation period is no less than one radio frame); or
if the IE P-Max as defined in TS 38.331 V17.3.0 is provided and set to the maximum output power of the default power class or lower;
A UE may be applied with all requirements for the default power class (=PC3) to the supported power class and set the configured transmitted power as specified in clause 6.2A.4 in TS38.101-1;
else; A UE may be applied with all requirements for the supported power class (PC2) and set the configured transmitted power as specified in clause 6.2A.4 (regardless of the average percentage of uplink symbols if the field of UE capability maxUplinkDutyCycle-interBandCA-PC2 is absent).

The average percentage of uplink symbols is defined as (X=)50%*(Duty_{NR,x}/maxDuty_{NR,x}+Duty_{NR,y}/maxDuty_{NR,y}). Duty_{NR,x}, Duty_{NR,y} represent(or, are related to) the actual percentage of uplink symbols.
transmitted in the same evaluation period (The exact evaluation period is no less than one radio frame) for NR Band x, NR Band y respectively; maxDuty_{NR,x}, maxDuty_{NR,y} represent(or, are related to) the field of UE capability maxUplinkDutyCycle-PC2-FR1 per band as defined in TS 38.331. For NR Band x or NR Band y,
if power class of one or both of the bands within the band combination is power class 2 and the corresponding UE capability maxUplinkDutyCycle-PC2-FR1 is absent;
the corresponding maxDuty_{NR,x} or maxDuty_{NR,y} is equal to 50%;
else if the band is configured with power class 3, the corresponding maxDuty_{NR,x} or maxDuty_{NR,y} is equal to 100%.

For the existing PC2 inter-band CA (e.g., PC3+PC2 CA), the following is applied:
X>Z1, PC3 requirements applies
X≤Z1, PC2 requirements applies

However, inter-band CA requirements for PC 1.5 has not been considered.

For PC1.5 inter-band CA (e.g., PC3+PC1.5 CA), 2 alternatives can be considered.

Note that Alt 1 is related to[Case 2: UE maximum output power for inter-band UL CA] and [Case 2: UE configured transmission power for uplink inter band CA]. Alt 2 is related to [Case 1: UE maximum output power for inter-band UL CA] and [Case1: UE configured transmission power for uplink inter band CA].

Alt 1) 0.5*maxUplinkDutyCycle-interBandCA-PC2 may be used for PC1.5 threshold, e.g, 0.5*Z1,
X>Z1, PC3 requirements applies
0.5*Z1<X≤Z1, PC2 requirements applies
X≤0.5*Z1, PC1.5 requirements applies

Alt 2) new_maxUplinkDutyCycle-interBandCA-PC1.5 may be used for PC1.5 threshold, e.g., Z2,
X>Z1, PC3 requirements applies
Z2<X≤Z1, PC2 requirements applies
X≤Z2, PC1.5 requirements applies

Here, X needs to be updated as follows.

X 50%*(Duty_{NR, x}/maxDuty_{NR,x}+Duty_{NR, y}/maxDuty_{NR,y})

maxDutyNR,x, maxDutyNR,y represent(or, are related to) the field of UE capability maxUplinkDutyCycle-PC2-FR1 per band or maxUplinkDutyCycle-PC1dot5-MPE-FR1-r1 per band as defined in TS 38.331. For NR Band x or NR Band y, the following is applied:
if power class of one or both of the bands within the band combination is power class 1.5 and the corresponding UE capability maxUplinkDutyCycle-PC1dot5-MPE-FR1-r1 is absent, the following is applied. The corresponding maxDutyNR,x or maxDutyNR,y may be equal to 25%;
else if power class of one or both of the bands within the band combination is power class 2 and the corresponding UE capability maxUplinkDutyCycle-PC2-FR1 is absent, the following is applied. The corresponding maxDutyNR,x or maxDutyNR,y may be equal to 50%;
else if the band is configured with power class 3, the corresponding maxDutyNR,x or maxDutyNR,y may be equal to 100%.

Proposal 2: Define either Alt 1 or Alt 2 for inter-band CA PC1.5. RF architecture for inter-band CA PC1.5 may be implemented with 3TX.

Alt 1) 0.5*maxUplinkDutyCycle-interBandCA-PC2 may be used for PC1.5 threshold, e.g., 0.5*Z1,
X>Z1, PC3 requirements applies
0.5*Z1<X≤Z1, PC2 requirements applies
X≤0.5*Z1, PC1.5 requirements applies

Alt 2) new_maxUplinkDutyCycle-interBandCA-PC1.5 may be used for PC1.5 threshold, e.g, Z2,
X>Z1, PC3 requirements applies
Z2<X≤Z1, PC2 requirements applies
X≤Z2, PC1.5 requirements applies

Alt 1 is in case that new signaling is not defined and the existing signaling of inter-band CA PC2 is used for inter-band CA PC1.5.

Alt 2 is in case that new signaling is defined for inter-band CA PC1.5. For example, ‘maxUplinkDutyCycle-interBandCA-PC1dot5-r18’ in [Case 1: UE maximum output power for inter-band UL CA].

Proposal 3: Update the corresponding maxDutyNR,x or maxDutyNR,y.

maxDutyNR,x, maxDutyNR,y represent(or, are related to) the field of UE capability maxUplinkDutyCycle-PC2-FR1 per band or maxUplinkDutyCycle-PC1dot5-MPE-FR1-r1 per band as defined in TS 38.331. For NR Band x or NR Band y,
if power class of one or both of the bands within the band combination is power class 1.5 and the corresponding UE capability maxUplinkDutyCycle-PC1dot5-MPE-FR1-r1 is absent: the corresponding maxDutyNR,x or maxDutyNR,y is equal to 25%;
else if power class of one or both of the bands within the band combination is power class 2 and the corresponding UE capability maxUplinkDutyCycle-PC2-FR1 is absent: the corresponding maxDutyNR,x or maxDutyNR,y is equal to 50%;
else if the band is configured with power class 3: the corresponding maxDutyNR,x or maxDutyNR,y is equal to 100%.

Proposal 3a: Update the corresponding maxDutyNR,x or maxDutyNR,y.

maxDutyNR,x, maxDutyNR,y represent(or, be related to) the field of UE capability maxUplinkDutyCycle-PC2-FR1 per band or maxUplinkDutyCycle-PC1dot5-MPE-FR1-r1 per band as defined in TS 38.331. For NR Band x or NR Band y,
if power class of one or both of the bands within the band combination is power class 1.5 and the corresponding UE capability maxUplinkDutyCycle-PC2-FR1 is absent and maxUplinkDutyCycle-PC1dot5-MPE-FR1-r1 is absent: the corresponding maxDutyNR,x or maxDutyNR,y is equal to 25%;
else if power class of one or both of the bands within the band combination is power class 1.5 and the corresponding UE capability maxUplinkDutyCycle-PC2-FR1 is absent and maxUplinkDutyCycle-PC1dot5-MPE-FR1-r1 is not absent: the corresponding maxDutyNR,x or maxDutyNR,y is equal to maxUplinkDutyCycle-PC1dot5-MPE-FR1-r1(%);
else if power class of one or both of the bands within the band combination is power class 1.5 and the corresponding UE capability maxUplinkDutyCycle-PC2-FR1 is not absent and maxUplinkDutyCycle-PC1dot5-MPE-FR1-r1 is absent: the corresponding maxDutyNR,x or maxDutyNR,y is equal to 0.5*maxUplinkDutyCycle-PC2-FR1(%);
else if power class of one or both of the bands within the band combination is power class 1.5 and the corresponding UE capability maxUplinkDutyCycle-PC2-FR1 is not absent and maxUplinkDutyCycle-PC1dot5-MPE-FR1-r1 is not absent: the corresponding maxDutyNR,x or maxDutyNR,y is equal to min{0.5*maxUplinkDutyCycle-PC2-FR1, maxUplinkDutyCycle-PC1dot5-MPE-FR1-r1}(%);
else if power class of one or both of the bands within the band combination is power class 2 and the corresponding UE capability maxUplinkDutyCycle-PC2-FR1 is absent and maxUplinkDutyCycle-PC1dot5-MPE-FR1-r1 is absent: the corresponding maxDutyNR,x or maxDutyNR,y is equal to 50%;
else if power class of one or both of the bands within the band combination is power class 2 and the corresponding UE capability maxUplinkDutyCycle-PC2-FR1 is absent and maxUplinkDutyCycle-PC1dot5-MPE-FR1-r1 is not absent: the corresponding maxDutyNR,x or maxDutyNR,y is equal to 2*maxUplinkDutyCycle-PC1dot5-MPE-FR1-r1(%);
else if power class of one or both of the bands within the band combination is power class 2 and the corresponding UE capability maxUplinkDutyCycle-PC2-FR1 is not absent and maxUplinkDutyCycle-PC1dot5-MPE-FR1-r1 is absent: the corresponding maxDutyNR,x or maxDutyNR,y is equal to maxUplinkDutyCycle-PC2-FR1(%);
else if power class of one or both of the bands within the band combination is power class 2 and the corresponding UE capability maxUplinkDutyCycle-PC2-FR1 is not absent and maxUplinkDutyCycle-PC1dot5-MPE-FR1-r1 is not absent: the corresponding maxDutyNR,x or maxDutyNR,y is equal to min{maxUplinkDutyCycle-PC2-FR1, 2*maxUplinkDutyCycle-PC1dot5-MPE-FR1-r1}(%);
else if the band is configured with power class 3: the corresponding maxDutyNR,x or maxDutyNR,y is equal to 100%.

Or, Proposal 3b: Update the corresponding maxDutyNR,x or maxDutyNR,y.

maxDutyNR,x, maxDutyNR,y represent(or, are related to) the field of UE capability maxUplinkDutyCycle-PC2-FR1 per band or maxUplinkDutyCycle-PC1dot5-MPE-FR1-r1 per band as defined in TS 38.331. For NR Band x or NR Band y,
if power class of one or both of the bands within the band combination is power class 1.5 and the corresponding UE capability maxUplinkDutyCycle-PC2-FR1 is absent and maxUplinkDutyCycle-PC1dot5-MPE-FR1-r1 is absent: the corresponding maxDutyNR,x or maxDutyNR,y is equal to 25%;
else if power class of one or both of the bands within the band combination is power class 1.5 and the corresponding UE capability maxUplinkDutyCycle-PC2-FR1 is absent and maxUplinkDutyCycle-PC1dot5-MPE-FR1-r1 is not absent; the corresponding maxDutyNR,x or maxDutyNR,y is equal to max{25, maxUplinkDutyCycle-PC1dot5-MPE-FR1-r1}(%);
else if power class of one or both of the bands within the band combination is power class 1.5 and the corresponding UE capability maxUplinkDutyCycle-PC2-FR1 is not absent and maxUplinkDutyCycle-PC1dot5-MPE-FR1-r1 is absent: the corresponding maxDutyNR,x or maxDutyNR,y is equal to max{25, 0.5*maxUplinkDutyCycle-PC2-FR1}(%);
else if power class of one or both of the bands within the band combination is power class 1.5 and the corresponding UE capability maxUplinkDutyCycle-PC2-FR1 is not absent and maxUplinkDutyCycle-PC1dot5-MPE-FR1-r1 is not absent: the corresponding maxDutyNR,x or maxDutyNR,y is equal to max{25, min{0.5*maxUplinkDutyCycle-PC2-FR1, maxUplinkDutyCycle-PC1dot5-MPE-FR1-r1}}(%);
else if power class of one or both of the bands within the band combination is power class 2 and the corresponding UE capability maxUplinkDutyCycle-PC2-FR1 is absent and maxUplinkDutyCycle-PC1dot5-MPE-FR1-r1 is absent: the corresponding maxDutyNR,x or maxDutyNR,y is equal to 50%;
else if power class of one or both of the bands within the band combination is power class 2 and the corresponding UE capability maxUplinkDutyCycle-PC2-FR1 is absent and maxUplinkDutyCycle-PC1dot5-MPE-FR1-r1 is not absent: the corresponding maxDutyNR,x or maxDutyNR,y is equal to max{50, 2*maxUplinkDutyCycle-PC1dot5-MPE-FR1-r1}(%);
else if power class of one or both of the bands within the band combination is power class 2 and the corresponding UE capability maxUplinkDutyCycle-PC2-FR1 is not absent and maxUplinkDutyCycle-PC1dot5-MPE-FR1-r1 is absent: the corresponding maxDutyNR,x or maxDutyNR,y is equal to max{50, maxUplinkDutyCycle-PC2-FR1}(%);
else if power class of one or both of the bands within the band combination is power class 2 and the corresponding UE capability maxUplinkDutyCycle-PC2-FR1 is not absent and maxUplinkDutyCycle-PC1dot5-MPE-FR1-r1 is not absent: the corresponding maxDutyNR,x or maxDutyNR,y is equal to max{50, min{maxUplinkDutyCycle-PC2-FR1, 2*maxUplinkDutyCycle-PC1dot5-MPE-FR1-r1}}(%);
else if the band is configured with power class 3: the corresponding maxDutyNR,x or maxDutyNR,y is equal to 100%.

Or, Proposal 3c: Update the corresponding maxDutyNR,x or maxDutyNR,y.
maxDutyNR,x, maxDutyNR,y represent(or, are related to) the field of UE capability maxUplinkDutyCycle-PC2-FR1 per band or maxUplinkDutyCycle-PC1dot5-MPE-FR1-r1 per band as defined in TS 38.331. For NR Band x or NR Band y,
if power class of one or both of the bands within the band combination is power class 1.5 and the corresponding UE capability maxUplinkDutyCycle-PC2-FR1 is absent and maxUplinkDutyCycle-PC1dot5-MPE-FR1-r1 is absent: the corresponding maxDutyNR,x or maxDutyNR,y is equal to 25%;
else if power class of one or both of the bands within the band combination is power class 1.5 and the corresponding UE capability maxUplinkDutyCycle-PC2-FR1 is absent and maxUplinkDutyCycle-PC1dot5-MPE-FR1-r1 is not absent: the corresponding maxDutyNR,x or maxDutyNR,y is equal to min{25, maxUplinkDutyCycle-PC1dot5-MPE-FR1-r1}(%);
else if power class of one or both of the bands within the band combination is power class 1.5 and the corresponding UE capability maxUplinkDutyCycle-PC2-FR1 is not absent and maxUplinkDutyCycle-PC1dot5-MPE-FR1-r1 is absent: the corresponding maxDutyNR,x or maxDutyNR,y is equal to min{25, 0.5*maxUplinkDutyCycle-PC2-FR1}(%);
else if power class of one or both of the bands within the band combination is power class 1.5 and the corresponding UE capability maxUplinkDutyCycle-PC2-FR1 is not absent and maxUplinkDutyCycle-PC1dot5-MPE-FR1-r1 is not absent: the corresponding maxDutyNR,x or maxDutyNR,y is equal to min{25, min{0.5*maxUplinkDutyCycle-PC2-FR1, maxUplinkDutyCycle-PC1dot5-MPE-FR1-r1}}(%);
else if power class of one or both of the bands within the band combination is power class 2 and the corresponding UE capability maxUplinkDutyCycle-PC2-FR1 is absent and maxUplinkDutyCycle-PC1dot5-MPE-FR1-r1 is absent: the corresponding maxDutyNR,x or maxDutyNR,y is equal to 50%;
else if power class of one or both of the bands within the band combination is power class 2 and the corresponding UE capability maxUplinkDutyCycle-PC2-FR1 is absent and maxUplinkDutyCycle-PC1dot5-MPE-FR1-r1 is not absent: the corresponding maxDutyNR,x or maxDutyNR,y is equal to min{50, 2*maxUplinkDutyCycle-PC1dot5-MPE-FR1-r1}(%);
else if power class of one or both of the bands within the band combination is power class 2 and the corresponding UE capability maxUplinkDutyCycle-PC2-FR1 is not absent and maxUplinkDutyCycle-PC1dot5-MPE-FR1-r1 is absent: the corresponding maxDutyNR,x or maxDutyNR,y is equal to min{50, maxUplinkDutyCycle-PC2-FR1}(%);
else if power class of one or both of the bands within the band combination is power class 2 and the corresponding UE capability maxUplinkDutyCycle-PC2-FR1 is not absent and maxUplinkDutyCycle-PC1dot5-MPE-FR1-r1 is not absent: the corresponding maxDutyNR,x or maxDutyNR,y is equal to min{50, min{maxUplinkDutyCycle-PC2-FR1, 2*maxUplinkDutyCycle-PC1dot5-MPE-FR1-r1}}(%);
else if the band is configured with power class 3: the corresponding maxDutyNR,x or maxDutyNR,y is equal to 100%.

### [Case1: UE Configured Transmission Power for Uplink Inter Band CA]

Generally, UE configured transmission power for uplink inter band CA follows the requirement of 6.2A.4.1.3 in TS38.101-1 except for ΔP_{PowerClass,CA}. ΔP_{PowerClass,CA} is proposed in the present disclosure as below.

For uplink carrier aggregation the UE is allowed to set its configured maximum output power P_{CMAX,c} for serving cell c and its total configured maximum output power P_{CMAX}.

The configured maximum output power P_{CMAX,c} on serving cell c shall be set as specified in clause 6.2.4, except that the UE power class for serving cell c on the specific operating band shall be determined by the ue-PowerClassPerBandPerBC-r17 IE as indicated for the band combination if ue-PowerClassPerBandPerBC-r17 is transmitted(or signalled) by the UE.

For uplink inter-band carrier aggregation, MPR_{c} and A-MPR_{c} apply per serving cell c and are specified in clause 6.2.2 in TS 38.101-1 V17.3.0 and clause 6.2.3 in TS 38.101-1 V17.3.0, respectively. P-MPR_{c} accounts for power management for serving cell c. P_{CMAX,c} is calculated under the assumption that the transmit power is increased independently on all component carriers.

The total configured maximum output power P_{CMAX} shall be set within the following bounds:

$${P}_{CMAX\_L} \leq {P}_{CMAX} \leq {P}_{CMAX\_H}$$

For uplink inter-band carrier aggregation with one serving cell c per operating band when same slot symbol pattern is used in all aggregated serving cells, P_{CMAX_L} and P_{CMAX_H} may be defined as the following:

$${P}_{CMAX\_L} = MIN \{ 10 {log}_{10} \sum MIN [ {p}_{EMAX , c} / ( Δ {t}_{C , c} ) , {p}_{PowerClass , c} / ( MAX ( {mpr}_{c} * Δ {mpr}_{c} , a - {mpr}_{c} ) * Δ {t}_{C , c} * Δ {t}_{IB , c} * Δ {t}_{R \times SRS , c} ) , {p}_{PowerClass , c} / {pmpr}_{c} ] , {P}_{EMAX , CA} , {P}_{PowerClass , CA} - Δ {P}_{PowerClass , CA} \}$$

$${P}_{CMAX\_H} = MIN \{ 10 * {log}_{10} \sum {p}_{EMAX , c} , {P}_{EMAX , CA} , {P}_{PowerClass , CA} - Δ {P}_{PowerClass , CA} \}$$

where
p_{EMAX,c} is the linear value of P_{EMAX,c} which is given by IE P-Max for serving cell c in TS38.331;
P_{PowerClass,CA} is the maximum UE power based on a power class, such as, PC3, PC2, or PC1.5 without taking into account the tolerance; If the UE indicates higherPowerLimit-r17 for an eligible CA configuration and ΔP_{PowerClass, CA}=0, P_{PowerClass,CA} may be replaced by 10 log₁₀ Σp_{PowerClass,c}.
p_{PowerClass,c} is the linear value of the maximum UE power for serving cell c specified in Table 6.2.1-1 in TS38.101-1 according to ue-PowerClassPerBandPerBC-r17 if indicated, or according to ue-PowerClass otherwise without taking into account the tolerance;
ΔP_{PowerClass,CA}=3 dB for a power class 2 capable UE when the requirements of default power class are applied as specified in sub-clause 6.2.A.1.3; otherwise ΔP_{PowerClass, CA}=0 dB;
ΔP_{PowerClass,CA} is,
ΔP_{PowerClass,CA} may be 3 dB for a power class 2 capable UE or 6 dB for a power class 1.5 UE, for one of the following cases:
i) when P-max of 23 dBm or lower is indicated; or
ii) when the field of UE capability maxUplinkDutyCycle-interBandCA-PC2-r17 is absent and the field of UE capability maxUplinkDutyCycle-interBandCA-PC1dot5-r18 is absent and if the IE P-Max as defined in TS 38.331 is provided and set to the maximum output power of the default power class or lower; or
iii) when the field of UE capability maxUplinkDutyCycle-interBandCA-PC2-r17 is not absent and the average percentage of uplink symbols transmitted in a certain evaluation period is larger than maxUplinkDutyCycle-interBandCA-PC2-r17 as defined in TS 38.306 (The exact evaluation period is no less than one radio frame); or
iv) when the field of UE capability maxUplinkDutyCycle-interBandCA-PC1dot5-r18 is not absent and half the average percentage of uplink symbols transmitted in a certain evaluation period is larger than maxUplinkDutyCycle-interBandCA-PC1dot5-r18 (The exact evaluation period is no less than one radio frame).
ΔP_{PowerClass,CA} may be 3 dB for a power class 1.5 capable UE, for one of the following cases:
i) when P-max of between 23 dBm and 26 dB is indicated; or
ii) when the field of UE capability maxUplinkDutyCycle-interBandCA-PC2-r17 is absent and the field of UE capability maxUplinkDutyCycle-interBandCA-PC1dot5-r18 is absent and if the IE P-Max as defined in TS 38.331 is provided and set to the maximum output power of the power class 2 or lower; or
iii) when the field of UE capability maxUplinkDutyCycle-interBandCA-PC2-r17 is not absent and the average percentage of uplink symbols transmitted in a certain evaluation period is between maxUplinkDutyCycle-interBandCA-PC2-r17 and 0.5*maxUplinkDutyCycle-interBandCA-PC2-r17 (The exact evaluation period is no less than one radio frame); or
iv) when the field of UE capability maxUplinkDutyCycle-interBandCA-PC1dot5-r18 is not absent and the average percentage of uplink symbols transmitted in a certain evaluation period is larger than maxUplinkDutyCycle-interBandCA-PC1dot5-r18 (The exact evaluation period is no less than one radio frame
ΔP_{PowerClass,CA} may be 0 dB otherwise.
mpr_{c} and a-mpr_{c} are the linear values of MPR_{c} and A-MPR_{c} as specified in clause 6.2.2 and clause 6.2.3 in TS38.101-1, respectively;
Δmpr_{c} is the linear value of ΔMPR_{c} as specified in clause 6.2.2 in TS38.101-1;
pmpr_{c} is the linear value of P-MPR_{c};
Δt_{RxSRS,c} is the linear value of ΔT_{RxSRS,c}. Here, ΔT_{RxSRS,c} is a value related to Sounding Reference Signal (SRS) transmission;
Δt_{C,c} is the linear value of ΔT_{C,c}. Δt_{C,c}=1.41 when NOTE 2 in Table 6.2A.1.3-1 in TS38.101-1 applies for a serving cell c, otherwise Δt_{C,c}=1;

Δt_{IB,c} is the linear value of the inter-band relaxation term ΔT_{IB,c} of the serving cell c as specified in clause 6.2A.4.2 in TS38.101-1; otherwise Δt_{IB,c}=1; case the UE supports more than one of band combinations for CA, and an operating band belongs to more than one band combinations then
a) When the operating band frequency range is ≤1 GHz, the applicable additional ΔT_{IB,c} shall be the average value for all band combinations defined in clause 6.2A.4.2, 6.2C.2 in TS 38.101-1 and 6.2B.4.2 in TS 38.101-3, truncated to one decimal place that apply for that operating band among the supported band combinations. In case there is a harmonic relation between low band UL and high band DL, then the maximum ΔT_{IB,c} among the different supported band combinations involving such band shall be applied.
b) When the operating band frequency range is >1 GHz, the applicable additional T_{IB,c} shall be the maximum value for all band combinations defined in clause 6.2A.4.2, 6.2C.2 in this specification and 6.2B.4.2 in TS 38.101-3 for the applicable operating bands.
P_{EMAX,CA} is the value indicated by p-NR-FR1 or by p-UE-FR1 whichever is the smallest if both are present. For uplink inter-band carrier aggregation with one serving cell c per operating band when at least one different numerology/slot pattern is used in aggregated cells, the UE is allowed to set its configured maximum output power Pc_{MAX,c(i),i} for serving cell c(i) of slot numerology type i, and its total configured maximum output power PCMAX.

### [Case 2: UE Configured Transmission Power for Uplink Inter Band CA]

Generally, UE configured transmission power for uplink inter band CA follows the requirement of 6.2A.4.1.3 in TS38.101-1 except for ΔP_{PowerClass,CA}.ΔP_{PowerClass,CA} is proposed in the present disclosure as below.

For uplink carrier aggregation the UE is allowed to set its configured maximum output power P_{CMAX,c} for serving cell c and its total configured maximum output power P_{CMAX}.

The configured maximum output power P_{CMAX,c} on serving cell c shall be set as specified in clause 6.2.4, except that the UE power class for serving cell c on the specific operating band shall be determined by the ue-PowerClassPerBandPerBC-r17 IE as indicated for the band combination if signalled.

For uplink inter-band carrier aggregation, MPR_{c} and A-MPR_{c} apply per serving cell c and are specified in clause 6.2.2 and clause 6.2.3 in TS 38.101-1, respectively. P-MPR_{c} accounts for power management for serving cell c. P_{CMAX,c} is calculated under the assumption that the transmit power is increased independently on all component carriers.

The total configured maximum output power P_{CMAX} shall be set within the following bounds:

$${P}_{CMAX\_L} \leq {P}_{CMAX} \leq {P}_{CMAX\_H}$$

For uplink inter-band carrier aggregation with one serving cell c per operating band when same slot symbol pattern is used in all aggregated serving cells, PCMAX_L and PCMAX_H may be defined as the following:

$${P}_{CMAX\_L} = MIN \{ 10 {log}_{10} \sum MIN [ {p}_{EMAX , c} / ( Δ {t}_{C , c} ) , {p}_{PowerClass , c} / ( MAX ( {mpr}_{c} * Δ {mpr}_{c} , a - {mpr}_{c} ) * Δ {t}_{C , c} * Δ {t}_{IB , c} * Δ {t}_{R \times SRS , c} ) , {p}_{PowerClass , c} / {pmpr}_{c} ] , {P}_{EMAX , CA} , {P}_{PowerClass , CA} - {ΔP}_{PowerClass , CA} \}$$

$${P}_{CMAX\_H} = MIN \{ 10 * {log}_{10} \sum {p}_{EMAX , c} , {P}_{EMAX , CA} , {P}_{PowerClass , CA} - Δ {P}_{PowerClass , CA} \}$$

where
p_{EMAX,c} is the linear value of P_{EMAX,c} which is given by IE P-Max for serving cell c in TS38.331;

P_{PowerClass,CA} is the maximum UE power based on a power class, such as, PC3, PC2, or PC1.5 without taking into account the tolerance; If the UE indicates higherPowerLimit-r17 for an eligible CA configuration and ΔP_{PowerClass, CA}=0, P_{PowerClass,CA} is replaced by 10 log₁₀ Σp_{PowerClass,c}.
p_{PowerClass,c} is the linear value of the maximum UE power for serving cell c specified in Table 6.2.1-1 in TS38.101-1 according to ue-PowerClassPerBandPerBC-r17 if indicated or ue-PowerClass otherwise without taking into account the tolerance;
ΔP_{PowerClass,CA}=3 dB for a power class 2 capable UE when the requirements of default power class are applied as specified in sub-clause 6.2.A.1.3; otherwise ΔP_{PowerClass, CA}=0 dB;
ΔP_{PowerClass,CA}=6 dB for a power class 1.5 capable UE when the requirements of default power class are applied as [Case2: UE maximum output power for inter-band UL CA] in the present disclosure; ΔP_{PowerClass,CA}=3 dB for a power class 1.5 capable UE when the requirements of power class 2 are applied as [Case2: UE maximum output power for inter-band UL CA] in the present disclosure; otherwise ΔP_{PowerClass, CA}=0 dB;

Other parameters are same with parameters in Case 1.

The UE may be configured to satisfy requirements related to transmitter power for CA with UL MIMO, according to the present disclosure. For example, based on the examples of the present disclosure, the UE may be configured to satisfy requirements related to transmitter power for inter-band UL CA with UL MIMO.

For example, for inter-band UL CA with UL MIMO in one of the two frequency bands, the maximum output power is defined as the sum of the maximum output power from all UE antenna connectors and all UL CCs, as specified in Table 8. The period of measurement shall be at least one sub frame (1 ms). The requirements shall be met with the UL MIMO configurations specified in Table 6.2D.1-2 and 6.2D.1-3 in TS 38.101-1 for 2-layer configuration and ULFPTx configuration respectively for the component carrier configured with UL MIMO.

TABLE 8

| NR UL CA | Class 1.5 | Tolerance | Class 2 | Tolerance | Class 3 | Tolerance |
|---|---|---|---|---|---|---|
| Configuration | (dBm) | (dB) | (dBm) | (dB) | (dBm) | (dB) |
| CA_n2A-n77A | 29(Note 3 | +2/−3 | 26 | +2/−3 | 23 | +2/−3 |
| | applied) | | (Note 2 | | | |
| | | | applied) | | | |
| CA_n5A-n77A | 29(Note 3 | +2/−3 | | | 23 | +2/−3 |
| | applied) | | | | | |
| CA_n8A-n78A | | | 26(Note 2 | +2/−3 | 23 | +2/−3 |
| | | | applied) | | | |
| CA_n25A- | 29(Note 3 | +2/−3 | 26 | +2/−3 | 23 | +2/−3 |
| n41A | applied) | | (Note 2 | | | |
| | | | applied) | | | |
| CA_n25A- | 29(Note 3 | +2/−3 | | | 23 | +2/−3 |
| n77A | applied) | | | | | |
| CA_n26A- | | | 26(Note 2 | +2/−3 | 23 | +2/−3 |
| n78A | | | applied) | | | |
| CA_n28A- | | | 26(Note 2 | +2/−3 | 23 | +2/−3 |
| n41A | | | applied) | | | |
| CA_n28A- | | | 26(Note 2 | +2/−3 | 23 | +2/−3 |
| n78A | | | applied) | | | |
| CA_n41A- | 29(Note 3 | +2/−3 | 26 | +2/−3 | 23 | +2/−3 |
| n66A | applied) | | (Note 2 | | | |
| | | | applied) | | | |
| CA_n41A- | 29(Note 3 | +2/−3 | 26 | +2/−3 | 23 | +2/−3 |
| n71A | applied) | | (Note 2 | | | |
| | | | applied) | | | |
| CA_n41A- | | | 26(Note 4 | +2/−3 | 23 | +2/−3 |
| n77A | | | applied) | | | |

NOTE 1:
An uplink CA configuration in which at least one of the bands has NOTE 3 in Table 6.2.1-1 in TS 38.101-1 V17.3.0 is allowed to reduce the lower tolerance limit by 1.5 dB when the transmission bandwidths of at least one of the bands is confined within FUL low and FUL low + 4 MHz or FUL_high − 4 MHz and FUL_high.
NOTE 2:
The UE supports PC3 in FDD band and PC3 or PC2 with UL MIMO in TDD band.
NOTE 3:
The UE supports PC3 in FDD band and PC1.5 with UL MIMO in TDD band.
NOTE 4:
The UE supports PC2 with UL MIMO in either one of the TDD bands and PC2 in the other TDD band.
NOTE 5:
Power class 3 is default power class unless otherwise stated.
NOTE 6:
FWA form factor is targeted unless otherwise stated.

Table 8 shows examples of UE Power Class for inter-band UL CA with UL MIMO in one frequency band. For each power class among power class 1.5, 2, 3, the maximum output power shown in Table 8 is applied.

According to the present disclosure, maxUplinkDutyCycle-interBandCA-PC2 is an example of a capability information related to maximum uplink duty cycle for inter band CA for the power class 2. maxUplinkDutyCycle-PC1dot5-MPE-FR1 is an example of a capability information related to maximum uplink duty cycle for one band of inter band CA for the power class 1.5. The UE may support UL MIMO.

If a UE supports power class 1.5 for the band combination listed in Table 8:
if the UE has a capability information related to maximum uplink duty cycle for inter-band CA based on power class 2, (i.e., if the field of UE capability maxUplinkDutyCycle-interBandCA-PC2 is present) and
a1) if the average percentage of uplink symbols transmitted in a certain evaluation period is larger than maxUplinkDutyCycle-interBandCA-PC2 (The exact evaluation period is no less than one radio frame); or
a2) if 10 log₁₀ Σp_{EMAX,c} or P_{EMAX,CA} which defined in clause 6.2A.4.1.3 of 3GPP TS 38.101-1 V17.4.0 is 23 dBm or lower;
A) either one of a1 or a2 is satisfied, a UE may be applied with(e.g., configured to satisfy) all requirements for the default power class and the UE may set the configured transmitted power as specified in clause 6.2A.4.1.3 of 3GPP TS 38.101-1 V17.4.0;
b1) if the average percentage of uplink symbols transmitted in a certain evaluation period is larger than 0.5*maxUplinkDutyCycle-interBandCA-PC2 but less than or equal to maxUplinkDutyCycle-interBandCA-PC2; or
b2) if 10 log₁₀ Σp_{EMAX,c} or P_{EMAX,CA} which defined in clause 6.2A.4.1.3 of 3GPP TS 38.101-1 V17.4.0 is between 23 dBm and 26 dBm;
B) either one of b1 or b2 is satisfied, a UE may be applied with(e.g., configured to satisfy) all requirements for the power class 2 and set the configured transmitted power as specified in clause 6.2A.4.1.3;
C) else, a UE may be applied with(e.g., configured to satisfy) all requirements for the power class 1.5 and the UE may set the configured transmitted power as specified in clause 6.2A.4.1.3 (regardless of the average percentage of uplink symbols if the field of UE capability maxUplinkDutyCycle-interBandCA-PC2 is absent).

The average percentage of uplink symbols may be defined as 0.5*(Duty_{NR,x}/maxDuty_{NR,x}+Duty_{NR,y}/maxDuty_{NR,y}). Duty_{NR,x}, Duty_{NR,y} represent(or, are related to) the actual percentage of uplink symbols transmitted in the same evaluation period (The exact evaluation period is no less than one radio frame) for NR Band x, NR Band y respectively; maxDuty_{NR,x}, maxDuty_{NR,y} represent (or, are related to) the field of UE capability 0.5*maxUplinkDutyCycle-PC2-FR1 or maxUplinkDutyCycle-PC1dot5-MPE-FR1 per band as defined in TS 38.331 V17.3.0. For NR Band x or NR Band y,
if power class of one band within the band combination is power class 1.5. The UE may be configured with different power classes or same power class for bands included in the band combination. For example, as shown in NOTE 3 of Table 8, the UE may support PC3 for FDD band and PC 1.5 for TDD band with UL MIMO.:
a) if the corresponding UE capability 0.5*maxUplinkDutyCycle-PC2-FR1 and maxUplinkDutyCycle-PC1dot5-MPE-FR1 are both absent, the corresponding maxDutyNR,x or maxDutyNR,y may be equal to 25%;
b) else if only one of the corresponding UE capability 0.5*maxUplinkDutyCycle-PC2-FR1 and maxUplinkDutyCycle-PC1dot5-MPE-FR1 is reported by the UE, the corresponding maxDutyNR,x or maxDutyNR,y may be according to the reported capability;
c) else, the corresponding maxDutyNR,x or maxDutyNR,y is the smaller of maxUplinkDutyCycle-PC1dot5-MPE-FR1 and 0.5*maxUplinkDutyCycle-PC2-FR1;
if the band is configured with power class 3;
the corresponding maxDutyNR,x or maxDutyNR,y is equal to 100%.

Above mentioned clause 6.2H.3.4 is explained as the following: Configured transmitted power for inter-band UL CA with UL MIMO.

For inter-band UL CA with UL MIMO in one of the two frequency bands, the requirements related to the configured maximum output power for inter-band CA without UL MIMO in sub-clause 6.2A.4.1.3 in TS 38.101-1 apply except that:
P_{PowerClass,CA} is the maximum UE power specified in Table 8 without taking into account the tolerance;
MPRc and A-MPRc are specified in clause 6.2D.2 and clause 6.2D.3 of TS 38.101-1 respectively for the component carrier configured with UL MIMO.
ΔP_{PowerClass,CA}.
For a power class 2 capable UE, it is 3 dB when the requirements of default power class are applied as specified in sub-clause 6.2.H.3.1 in TS 38.101-1, otherwise ΔP_{PowerClass, CA} 0 dB;
For a power class 1.5 capable UE, it is 6 dB when the requirements of default power class are applied as specified in sub-clause 6.2.H.3.1 in TS 38.101-1; and it is 3 dB when the requirements of power class 2 are applied as specified in sub-clause 6.2.H.3.1 in TS 38.101-1; otherwise ΔP_{PowerClass, CA}=0 dB;

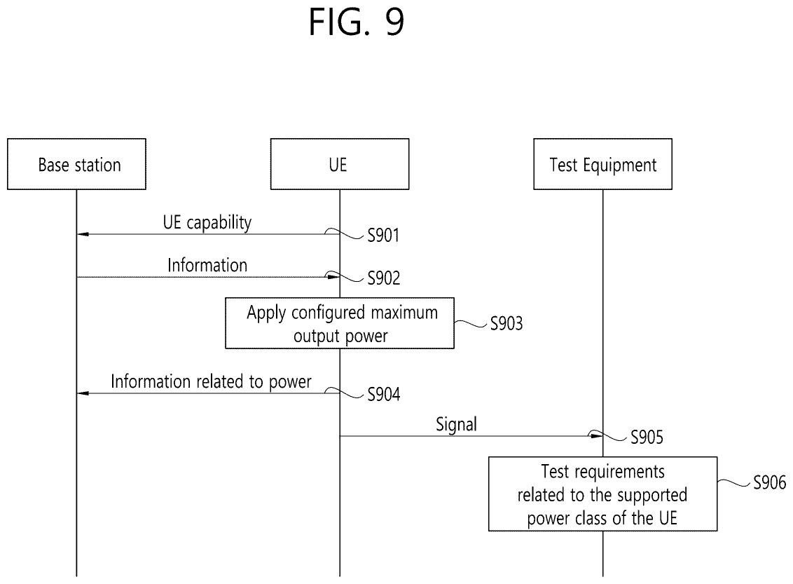

Based on examples explained above, requirements related to UE configured transmitter power PC 1.5 UE supporting inter-band CA are explained. Operations of a UE, a gNB, and/or a test equipment based on the requirements related to the present disclosure are explained based on FIG. 9

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIG. 9 illustrates an example of an operation according to an embodiment of the present disclosure.

FIG. 9 shows examples of behavior related to CA UE configured transmission power for uplink inter-band CA.

FIG. 9 shows operations related to CA UE configured transmission power and the requirements to be tested for uplink inter band CA. In the figure, UE may configure the CA transmission power based on the supported power class, MPRc, A-MPRc, ΔMPRc, ΔTIB,c, ATC,c, ΔTRxSRS, P-MPRc, and/or ΔP_{PowerClass,CA}. Here, PH is Power Headroom. P_{CMAX,C} and PH_{c} are reported per carrier(s) in each Band. And the measured configured transmission power, P_{UMAX}, should be met with the requirement of 6.2A.4.1.3 in TS38.101-1.

FIG. 9 describes examples of operations of a UE, a base station (e.g., gNB), and a test equipment. Operations are related to UE configured transmission power.

In step S901, the UE may transmit UE capability information.

For example, the UE capability information may include one or more of ue-PowerClass, PowerClass, UE-PowerClassPerBandPerBC, higherPowerLimit TxDiversity, and ulFullPowerMode.

For example, if the UE communicates based on single carrier, the terminal may transmit its power class in the form of power class per Band. In this case, the device sends ‘ue-PowerClass’. If the UE communicates based on CA, the device may inform the network of its power class based on CA power (total sum power) and power per cc. For example, the UE may transmit ‘PowerClass’ in the form of perBandCombination and ‘ue-PowerClass’ in the form of perBand to the network. For example, if a CA based on cc1 and cc2 is established, the UE may transmit the following information: —‘PowerClass’ per BandCombination (e.g, BandA, BandB combination)—‘ue-PowerClass’per Band A—‘ue-PowerClass’ per Band B In addition, the UE may also transmit ue-PowerClassPerBandPerBC.
‘ue-PowerClassPerBandPerBC’ perBandperBC (power for Band A of {Band A, Band B}) If there are both ‘ue-PowerClass’ and ‘ue-PowerClassperBandperBC’ power classes for Band A, ‘ue-PowerClassperBandperBC’ shall take precedence.

TxDiversity is information related to whether the Tx antenna port including PA is 1 or 2 (diversity). ulFullPowerMode is information related to the type of Full Power mode (mode-full, mode-1, mode-2) if the UE supports UL MIMO.

higherPowerLimit may indicates whether UE supports increase in maximum output power above the power class indication for inter-band UL CA band combinations.

In step S902, the base station may transmit information to the UE. The information may include information related to power, operating band, and/or modulation.

The information of Step S902 may include one or more of p-Max information, Band information, UL modulation information. p-Max information may include P_{EMAX,c}, P_{EMAX,CA}. Band information may be the band information that has been implemented to enable the service.

For example the UE may determine (or define) supported power class, MPRc, A-MPRc, ΔMPRc, ΔTIB,c, ΔTC,c, ΔTRxSRS, P-MPRc, ΔP_{PowerClass,CA}.

In step S903, the UE may apply configured maximum output power. The UE may determine transmission power for transmission signal based on the total configured maximum output power, P_{CMAX}.

In step S904, the UE may transmit information related to power to the base station, the information related to the power may include P_{CMAX,c}, and/or PH_{c}. PH means Power headroom.

In step S905, the UE may transmit signal based on the configured maximum output power to the test equipment.

In step S906, the test equipment may test the requirements of the supported power class of the UE. The requirements are based on the examples of the present disclosure.

For reference, step S905 and S906 may be skipped. For another example, step S905 and S906 may be performed before the UE is sold to a user.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

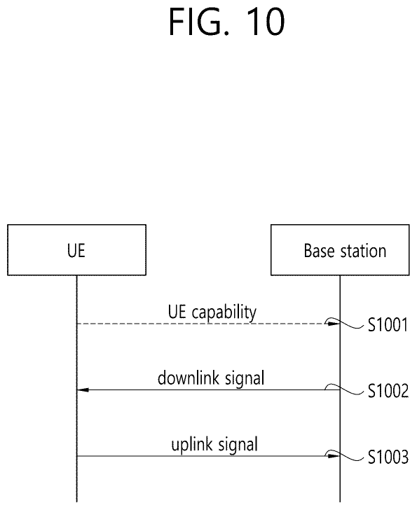

FIG. 10 illustrates an example of an operation according to an embodiment of the present disclosure.

In addition, the operations of the UE and the base station(e.g., gNB) shown in the example of FIG. 10 are only an example. The operation of the UE is not limited by the example of FIG. 10, and the UE and the base station may perform the operations described in various examples of the present specification.

In step S1001, the UE may transmit UE capability information to a base station.

The UE may support power class 1.5 for a band combination for the inter-band CA.

In step S1002, the base station may transmit downlink signal to the UE. For example, the base station may transmit downlink signal including one or more of may include one or more of p-Max information, Band information, UL modulation information. p-Max information may include P_{EMAX,c}, P_{EMAX,CA}. Band information may be the band information that has been implemented to enable the service. The base station may transmit information related to that the UE is configured with inter-band CA. The UE may be configured with inter-band CA.

In step S1003, the UE may transmit uplink signal.

The UE is applied with requirements related to power class 1.5, power class 2, and/or power class 3 based on the examples of the present disclosure.

The UE may determine transmission power based on the configured maximum output power or the total configured maximum output power according to the presnet disclosure. One of requirements for default power class, requirements for power class 2, or requirements for power class 1.5 is applied for the UE, based on (i) a capability information related to maximum uplink duty cycle for inter band CA for the power class 2, (ii) an average percentage of uplink symbols transmitted in a certain evaluation period.

For example, the requirements for default power class, which is power class 3, is applied for the UE, based on (i) that the capability information related to maximum uplink duty cycle for inter band CA for the power class 2 is present, and (ii) that the average percentage of uplink symbols transmitted is larger than maximum uplink duty cycle for inter band CA for the power class 2.

For example, the requirements for the power class 2 is applied for the UE, based on (i) that the capability information related to maximum uplink duty cycle for inter band CA for the power class 2 is present, and (ii) that the average percentage of uplink symbols is larger than a half of the maximum uplink duty cycle for inter band CA for the power class 2 but less than or equal to the the maximum uplink duty cycle for inter band CA.

For example, the requirements for the power class 1.5 is applied for the UE, based on (i) that the capability information related to maximum uplink duty cycle for inter band CA for the power class 2 is not present, or (ii) that the average percentage of uplink symbols is less than a half of the maximum uplink duty cycle for inter band CA for the power class 2.

For example, the average percentage of uplink symbols is equal to:

$$0.5 * ( {Duty}_{NR , x} / {maxDuty}_{NR , x} + {Duty}_{NR , y} / {maxDuty}_{NR , y} ) .$$

Herein, Duty_{NR,x}, Duty_{NR,y} represents(or, are related to) the actual percentage of uplink symbols transmitted in the same evaluation period for NR Band x, NR Band y respectively. NR Band x, and NR Band y are configured for the inter band CA,
wherein maxDuty_{NR,x} represents(or, is related to) the capability information related to maximum uplink duty cycle for inter band CA for the power class 2 or a capability information related to maximum uplink duty cycle for inter band CA for the power class 1.5. maxDuty_{NR},y represents(or, is related to) the capability information related to maximum uplink duty cycle for inter band CA for the power class 2 or the capability information related to maximum uplink duty cycle for inter band CA for the power class 1.5. maxDuty_{NR,y} represents(or, is related to) the capability information related to maximum uplink duty cycle for inter band CA for the power class 2 or the capability information related to maximum uplink duty cycle for inter band CA for the power class 1.5.

For example, based on (i) that power class of one band within the band combination is power class 1.5 and (ii) that the capability information related to maximum uplink duty cycle for inter band CA for the power class 2 and the capability information related to maximum uplink duty cycle for inter band CA for the power class 1.5 are both absent, wherein one of maxDuty_{NR,x} and maxDuty_{NR,y} related to the one band is equal to 25%.

For example, based on that the UE supports inter band CA for the power class 1.5, the UE may transmit uplink signal based on the total

For example, based on (i) that power class of one band within the band combination is power class 1.5 and (ii) that only one of the capability information related to maximum uplink duty cycle for inter band CA for the power class 2 and the capability information related to maximum uplink duty cycle for inter band CA for the power class 1.5 is reported by the UE, wherein one of maxDuty_{NR,x} and maxDuty_{NR,y} related to the one band equal to one of a half of the capability information related to maximum uplink duty cycle for inter band CA for the power class 2 and the capability information related to maximum uplink duty cycle for inter band CA for the power class 1.5 according to the reported capability information.

For example, based on (i) that power class of the one band within the band combination is power class 1.5 and (ii) that both of the capability information related to maximum uplink duty cycle for inter band CA for the power class 2 and the capability information related to maximum uplink duty cycle for inter band CA for the power class 1.5 are reported by the UE, wherein one of maxDuty_{NR,x} and maxDuty_{NR,y} related to the one band is equal to the smaller one of a half of the capability information related to maximum uplink duty cycle for inter band CA for the power class 2 and the capability information related to maximum uplink duty cycle for inter band CA for the power class 1.5.

For example, based on that power class of the one band within the band combination is power class 3, wherein one of maxDuty_{NR,x} and maxDuty_{NR,y} related to the one band is equal to 100%.

For example, if a UE supports power class 1.5 for the band combination listed in Table 8:
if the UE has a capability information related to maximum uplink duty cycle for inter-band CA based on power class 2, (i.e., if the field of UE capability maxUplinkDutyCycle-interBandCA-PC2 is present) and
a1) if the average percentage of uplink symbols transmitted in a certain evaluation period is larger than maxUplinkDutyCycle-interBandCA-PC2 (The exact evaluation period is no less than one radio frame); or
a2) if 10 log₁₀ Σp_{EMAX,c} or P_{EMAX,CA} which defined in clause 6.2H.3.4 is 23 dBm or lower;
A) either one of a1 or a2 is satisfied, a UE may be applied with(e.g., configured to satisfy) all requirements for the default power class and the UE may set the configured transmitted power as specified in clause 6.2H.3.4;
b1) if the average percentage of uplink symbols transmitted in a certain evaluation period is larger than 0.5*maxUplinkDutyCycle-interBandCA-PC2 but less than or equal to maxUplinkDutyCycle-interBandCA-PC2; or
b2) if 10 log₁₀ Σp_{EMAX,c} or P_{EMAX,CA} which defined in clause 6.2H.3.4 is between 23 dBm and 26 dBm;
B) either one of b1 or b2 is satisfied, a UE may be applied with(e.g., configured to satisfy) all requirements for the power class 2 and set the configured transmitted power as specified in clause 6.2H.3.4;
C) else, a UE may be applied with(e.g., configured to satisfy) all requirements for the power class 1.5 and the UE may set the configured transmitted power as specified in clause 6.2H.3.4 (regardless of the average percentage of uplink symbols if the field of UE capability maxUplinkDutyCycle-interBandCA-PC2 is absent).

The average percentage of uplink symbols may be defined as 0.5*(Duty_{NR,x}/maxDuty_{NR,x}+Duty_{NR,y}/maxDuty_{NR,y}). Duty_{NR,x}, Duty_{NR,y} represent(or, are related to) the actual percentage of uplink symbols transmitted in the same evaluation period (The exact evaluation period is no less than one radio frame) for NR Band x, NR Band y respectively; maxDuty_{NR,x}, maxDuty_{NR,y} represent(or, are related to) the field of UE capability 0.5*maxUplinkDutyCycle-PC2-FR1 or maxUplinkDutyCycle-PC1dot5-MPE-FR1 per band as defined in TS 38.331. For NR Band x or NR Band y,
if power class of one band within the band combination is power class 1.5:
a) if the corresponding UE capability 0.5*maxUplinkDutyCycle-PC2-FR1 and maxUplinkDutyCycle-PC1dot5-MPE-FR1 are both absent, the corresponding maxDutyNR,x or maxDutyNR,y may be equal to 25%;
b) else if only one of the corresponding UE capability 0.5*maxUplinkDutyCycle-PC2-FR1 and maxUplinkDutyCycle-PC1dot5-MPE-FR1 is reported by the UE, the corresponding maxDutyNR,x or maxDutyNR,y may be according to the reported capability;
c) else, the corresponding maxDutyNR,x or maxDutyNR,y is the smaller of maxUplinkDutyCycle-PC1dot5-MPE-FR1 and 0.5*maxUplinkDutyCycle-PC2-FR1;
if the band is configured with power class 3;
the corresponding maxDutyNR,x or maxDutyNR,y is equal to 100%.

According to an embodiment of the present disclosure, Requirements related to the supported maximum output power of CA UE for supporting uplink inter-band CA may be defined. For example, Applicable rule of the supported maximum output power of CA UE may be defined. Related UE capability may be defined.

According to an embodiment of the present disclosure, Requirements related to the configured transmission power of CA UE for supporting uplink inter-band CA may be defined. Fo example, applicable rule of the configured transmission power of CA UE may be defined. For example, related UE capability may be defined.

According to an embodiment of the present disclosure, operations, which are performed by a UE, a base station, and/or a test equipment, related to CA UE configured transmission power for uplink inter band CA may be defined.

The present specification may have various effects.

For example, CA coverage for UE supporting UL-MIMO is improved. For example, a wireless performance requirements for 3Tx-based PC1.5 inter-band CA UE may be defined in order to commercialize the UE and improve coverage. The UE supporting power class 1.5, inter-band CA, and MIMO may perform communication efficiently and/or precisely.

The effects that may be obtained from the specific examples of this disclosure are not limited to those listed above. For example, there may be a variety of technical effects that a person having ordinary skill in the related art may understand or infer from this disclosure. Accordingly, the specific effects of the present disclosure are not limited to those expressly set forth herein, but may include a variety of effects that may be understood or inferred from the technical features of the present disclosure.

For reference, the operation of the terminal (e.g., UE) described in the present specification may be implemented by the apparatus of FIGS. 1 to 4 described above. For example, the terminal (e.g., UE) may be the first device 100 or the second device 200 of FIG. 2. For example, an operation of a terminal (e.g., UE) described herein may be processed by one or more processors 102 or 202. The operation of the terminal described herein may be stored in one or more memories 104 or 204 in the form of an instruction/program (e.g., instruction, executable code) executable by one or more processors 102 or 202. One or more processors 102 or 202 control one or more memories 104 or 204 and one or more transceivers 105 or 206, and may perform the operation of the terminal (e.g., UE) described herein by executing instructions/programs stored in one or more memories 104 or 204.

In addition, instructions for performing an operation of a terminal (e.g., UE) described in the present disclosure of the present specification may be stored in a non-volatile computer-readable storage medium in which it is recorded. The storage medium may be included in one or more memories 104 or 204. And, the instructions recorded in the storage medium may be executed by one or more processors 102 or 202 to perform the operation of the terminal (e.g., UE) described in the present disclosure of the present specification.

For reference, the operation of a network node (e.g., AMF, SMF, UPF, test equipment, etc.) or base station (e.g., NG-RAN, gNB, eNB, RAN, E-UTRAN etc.) described herein may be implemented by the apparatus of FIGS. 1 to 3 to be described below. For example, a network node or a base station may be the first device 100 of FIG. 2 or the second device 200 of FIG. 2. For example, the operation of a network node or base station described herein may be processed by one or more processors 102 or 202. The operation of the terminal described herein may be stored in one or more memories 104 or 204 in the form of an instruction/program (e.g., instruction, executable code) executable by one or more processors 102 or 202. One or more processors 102 or 202 may perform the operation of a network node or a base station described herein, by controlling one or more memories 104 or 204 and one or more transceivers 106 or 206 and executing instructions/programs stored in one or more memories 104 or 204.

In addition, instructions for performing the operation of the network node or base station described in the present disclosure of the present specification may be stored in a non-volatile (or non-transitory) computer-readable storage medium. The storage medium may be included in one or more memories 104 or 204. And, the instructions recorded in the storage medium are executed by one or more processors 102 or 202, so that the operations of a network node or base station are performed.

In the above, preferred embodiments have been exemplarily described, but the present disclosure of the present specification is not limited to such specific embodiments, and thus, modifications, changes, or may be improved.

In the exemplary system described above, the methods are described on the basis of a flowchart as a series of steps or blocks, but are not limited to the order of the steps described, some steps may occur in a different order or concurrent with other steps as described above. In addition, those skilled in the art will understand that the steps shown in the flowchart are not exclusive and that other steps may be included or that one or more steps of the flowchart may be deleted without affecting the scope of rights.

The claims described herein may be combined in various ways. For example, the technical features of the method claims of the present specification may be combined and implemented as an apparatus, and the technical features of the apparatus claims of the present specification may be combined and implemented as a method. In addition, the technical features of the method claim of the present specification and the technical features of the apparatus claim may be combined to be implemented as an apparatus, and the technical features of the method claim of the present specification and the technical features of the apparatus claim may be combined and implemented as a method.

1-17. (canceled)

18. A user equipment (UE) comprising:
at least one transceiver;
at least one processor; and
at least one memory that stores instructions and is operably electrically connectable with the at least one processor,
wherein operations performed based on the instructions being executed by the at least one processor include:
transmitting capability information to a base station,
wherein inter-band Carrier Aggregation (CA) is configured for the UE,
wherein the UE supports power class 1.5 for a band combination for the inter-band CA, and
wherein one of requirements for default power class, requirements for power class 2, or requirements for power class 1.5 apply for the UE, based on (i) the capability information being related to maximum uplink duty cycle for inter band CA for the power class 2, (ii) an average percentage of uplink symbols transmitted in a certain evaluation period.

19. The UE of claim 18,
wherein the requirements for default power class, which is power class 3, apply for the UE, based on (i) that the capability information related to the maximum uplink duty cycle for inter band CA for the power class 2 is present, and (ii) that the average percentage of uplink symbols transmitted is larger than maximum uplink duty cycle for inter band CA for the power class 2.

20. The UE of claim 18,
wherein the requirements for the power class 2 apply for the UE, based on (i) that the capability information related to the maximum uplink duty cycle for inter band CA for the power class 2 is present, and (ii) that the average percentage of uplink symbols is larger than a half of the maximum uplink duty cycle for inter band CA for the power class 2 but less than or equal to the maximum uplink duty cycle for inter band CA.

21. The UE of claim 18,
wherein the requirements for the power class 1.5 apply for the UE, based on (i) that the capability information related to the maximum uplink duty cycle for inter band CA for the power class 2 is present, and (ii) that the average percentage of uplink symbols is less than or equal to a half of the maximum uplink duty cycle for inter band CA for the power class 2.

22. The UE of claim 18,
wherein the average percentage of uplink symbols is:
0.5*(DutyNR,x/maxDutyNR,x+DutyNR,y/maxDutyNR,y),
wherein DutyNR, x, DutyNR, y are related to the actual percentage of uplink symbols transmitted in the same evaluation period for NR Band x, NR Band y respectively,
wherein NR Band x, and NR Band y are configured for the inter band CA,
wherein maxDutyNR,x is related to the capability information related to the maximum uplink duty cycle for inter band CA for the power class 2 or a capability information related to maximum uplink duty cycle for inter band CA for the power class 1.5,
maxDutyNR,y is related to the capability information related to the maximum uplink duty cycle for inter band CA for the power class 2 or the capability information related to the maximum uplink duty cycle for inter band CA for the power class 1.5.

23. The UE of claim 22,
based on (i) that power class of one band within the band combination is power class 1.5 and (ii) that the capability information related to the maximum uplink duty cycle for inter band CA for the power class 2 and the capability information related to the maximum uplink duty cycle for inter band CA for the power class 1.5 are both absent, wherein one of maxDutyNR,x and maxDutyNR,y related to the one band is 25%.

24. The UE of claim 22,
based on (i) that power class of one band within the band combination is power class 1.5 and (ii) that only one of the capability information related to the maximum uplink duty cycle for inter band CA for the power class 2 and the capability information related to the maximum uplink duty cycle for inter band CA for the power class 1.5 is reported by the UE, wherein one of maxDutyNR,x and maxDutyNR,y related to the one band is one of a half of the capability information related to the maximum uplink duty cycle for inter band CA for the power class 2 and the capability information related to the maximum uplink duty cycle for inter band CA for the power class 1.5 according to the reported capability information.

25. The UE of claim 22,
based on (i) that power class of the one band within the band combination is power class 1.5 and (ii) that both of the capability information related to maximum uplink duty cycle for inter band CA for the power class 2 and the capability information related to maximum uplink duty cycle for inter band CA for the power class 1.5 are reported by the UE, wherein one of maxDutyNR,x and maxDutyNR,y related to the one band is the smaller one of a half of the capability information related to maximum uplink duty cycle for inter band CA for the power class 2 and the capability information related to maximum uplink duty cycle for inter band CA for the power class 1.5.

26. The UE of claim 22,
based on that power class of the one band within the band combination is power class 3, wherein one of maxDutyNR,x and maxDutyNR,y related to the one band is 100%.

27. A method performed by a User Equipment (UE) and comprising:
transmitting capability information to a base station,
wherein inter-band Carrier Aggregation (CA) is configured for the UE,
wherein the UE supports power class 1.5 for a band combination for the inter-band CA, and
wherein one of requirements for default power class, requirements for power class 2, or requirements for power class 1.5 apply for the UE, based on (i) the capability information being related to maximum uplink duty cycle for inter band CA for the power class 2, (ii) an average percentage of uplink symbols transmitted in a certain evaluation period.

28. The method of claim 27,
wherein the requirements for default power class, which is power class 3, apply for the UE, based on (i) that the capability information related to the maximum uplink duty cycle for inter band CA for the power class 2 is present, and (ii) that the average percentage of uplink symbols transmitted is larger than the maximum uplink duty cycle for inter band CA for the power class 2.

29. The method of claim 27,
wherein the requirements for the power class 2 apply for the UE, based on (i) that the capability information related to the maximum uplink duty cycle for inter band CA for the power class 2 is present, and (ii) that the average percentage of uplink symbols is larger than a half of the maximum uplink duty cycle for inter band CA for the power class 2 but less than or equal to the maximum uplink duty cycle for inter band CA.

30. The method of claim 27,
wherein the requirements for the power class 1.5 apply for the UE, based on (i) that the capability information related to the maximum uplink duty cycle for inter band CA for the power class 2 is present, and (ii) that the average percentage of uplink symbols is less than or equal to a half of the maximum uplink duty cycle for inter band CA for the power class 2.

31. A method performed by a base station and comprising:
receiving capability information from a User Equipment (UE),
wherein inter-band Carrier Aggregation (CA) is configured for the UE,
wherein the UE supports power class 1.5 for a band combination for the inter-band CA, and
wherein one of requirements for default power class, requirements for power class 2, or requirements for power class 1.5 apply for the UE, based on (i) the capability information being related to maximum uplink duty cycle for inter band CA for the power class 2, (ii) an average percentage of uplink symbols transmitted in a certain evaluation period.

32. The method of claim 31,
wherein the capability information includes at least one of the capability information related to the maximum uplink duty cycle for inter band CA for the power class 2, and a capability information related to maximum uplink duty cycle for inter band CA for the power class 1.5.
